(19) United States
(12) Patent Application Publication
(10) Pub. No.: US 2026/0218880 A1
(43) Pub. Date: Jul. 30, 2026

(54) LIGHT-EMITTING MODULE AND LENS

(71) Applicant: NICHIA CORPORATION, Anan-shi (JP)

(72) Inventor: Toshinobu KATSUMATA, Fujiyoshida-shi (JP)

(73) Assignee: NICHIA CORPORATION, Anan-shi (JP)

(21) Appl. No.: 19/458,342

(22) Filed: Jan. 23, 2026

(30) Foreign Application Priority Data
Jan. 30, 2025 (JP) 2025-013721
Dec. 16, 2025 (JP) 2025-256560

(51) Int. Cl. F21V 5/04; F21Y 113/00

(52) U.S. Cl. CPC F21V 5/04; F21Y 2113/00

(57) ABSTRACT

A light-emitting module includes: a lens having: a light incident surface that is concave upward, and a light-exiting surface; and a light source comprising a plurality of light-emitting units disposed below the lens. In a cross section passing through a center line of the light incident surface, the light incident surface includes: an inflection point at which the light incident surface changes from a concave surface to a convex surface, a first light incident surface located above the inflection point and comprising a concave surface that is concave upward, the first light incident surface being located in a central portion of the light incident surface in a top view, and a second light incident surface located below the inflection point and comprising a convex surface that is convex downward, the second light incident surface being located outward of the first light incident surface in the top view.

### CROSS-REFERENCE TO RELATED APPLICATION

This application claims priority to Japanese Patent Application No. 2025-013721, filed on Jan. 30, 2025 and to Japanese Patent Application No. 2025-256560, filed on Dec. 16, 2025. The entire disclosures of these applications are hereby incorporated by reference.

### TECHNICAL FIELD

The present disclosure relates to a light-emitting module and a lens.

### BACKGROUND

Light-emitting modules including semiconductor elements such as light-emitting diodes (LEDs) and an optical member such as a lens have been widely used. For example, Japanese Patent Publication No. 2013-134898 discloses an illumination device including a light source that has a plurality of light-emitting regions and can control the plurality of light-emitting regions to operate in light-emitting states different from each other, and an optical member having a plurality of light-exiting portions facing the respective light-emitting regions of the light source and configured to cause light from the respective light-exiting regions to exit in directions different from each other. In this illumination device, a plurality of light-emitting elements are two dimensionally arranged in each of the plurality of light-emitting regions.

### SUMMARY

An object of embodiments according to the present disclosure is to provide a light-emitting module and a lens suitable for variable light distribution.

A light-emitting module according to an embodiment of the present disclosure includes: a lens having a light incident surface that is concave upward; and a light-exiting surface located on an opposite side to the light incident surface, in which, in a cross section passing through a center line of the light incident surface, the light incident surface includes: an inflection point at which the light incident surface changes from a concave surface to a convex surface; a first light incident surface located above the inflection point, and including a concave surface that is continuous with the inflection point and is concave upward, the first light incident surface being located in a central portion of the light incident surface in a top view, and a second light incident surface located below the inflection point, and including a convex surface that is continuous with the inflection point and is convex downward, the second light incident surface being located outside the first light incident surface in a top view, and the light-exiting surface includes: a flat surface located on an opposite side to the first light incident surface; and a convex light-exiting surface that is located outside the flat surface and is convex upward in a top view; and a light source including a plurality of light-emitting units disposed below the lens, in which the plurality of light-emitting units include: in a top view, one or more first light-emitting units disposed in a central portion; and a plurality of second light-emitting units disposed outside the one or more first light-emitting units, the light-emitting module can emit light having a first light distribution angle and having passed through the lens when only the one or more first light-emitting units are caused to emit light, and can emit light having a second light distribution angle and having passed through the lens when only the plurality of second light-emitting units are caused to emit light, and the first light distribution angle is greater than the second light distribution angle.

A lens according to an embodiment of the present disclosure includes: a light incident surface that is concave upward; and a light-exiting surface located on an opposite side to the light incident surface. In a cross section passing through a center line of the light incident surface, the light incident surface comprises: an inflection point at which the light incident surface changes from a concave surface to a convex surface, a first light incident surface located above the inflection point, and comprising a concave surface that is continuous with the inflection point and is concave upward, the first light incident surface being located in a central portion of the light incident surface in a top view, and a second light incident surface located below the inflection point, and comprising a convex surface that is continuous with the inflection point and is convex downward, the second light incident surface being located outward of the first light incident surface in the top view. The light-exiting surface comprises: a flat surface located on an opposite side to the first light incident surface, and a convex light-exiting surface that is located outward of the flat surface in the top view and is convex upward. An outer shape of the light-exiting surface is a polygonal shape having an even number of vertices equal to or greater than six in the top view.

According to the embodiments of the present disclosure, the light-emitting module and the lens suitable for variable light distribution can be provided.

### BRIEF DESCRIPTION OF DRAWINGS

FIG. 1 is a schematic top view illustrating an overall configuration of a light-emitting module according to a first embodiment.

FIG. 2 is a schematic cross-sectional view taken along the line II-II in FIG. 1.

FIG. 3 is a schematic cross-sectional view of a lens in the light-emitting module according to the first embodiment.

FIG. 4 is a schematic top view of a light source in the light-emitting module according to the first embodiment.

FIG. 5 is a schematic cross-sectional view taken along the line V-V in FIG. 4.

FIG. 6 is a schematic view illustrating an example of a light emission pattern in a wide-angle mode of the light source in the light-emitting module according to the first embodiment.

FIG. 7 is a schematic view illustrating an example of a light emission pattern in a narrow-angle mode of the light source in the light-emitting module according to the first embodiment.

FIG. 8 is a schematic view illustrating an example of a light emission pattern in an intermediate mode of the light source in the light-emitting module according to the first embodiment.

FIG. 9 is a schematic cross-sectional view illustrating the behavior of light emitted from the light source of the light-emitting module according to the first embodiment.

FIG. 10 is a diagram illustrating a simulation result of an illuminance distribution on an irradiation plane in the light emission pattern of FIG. 6.

FIG. 11 is a diagram illustrating a simulation result of an illuminance distribution on an irradiation plane in the light emission pattern of FIG. 7.

FIG. 12 is a diagram illustrating a simulation result of an illuminance distribution on an irradiation plane in the light emission pattern of FIG. 8.

FIG. 13 is a diagram illustrating a simulation result of light distribution in the light emission pattern of FIG. 6.

FIG. 14 is a diagram illustrating a simulation result of light distribution in the light emission pattern of FIG. 7.

FIG. 15 is a diagram illustrating a simulation result of light distribution in the light emission pattern of FIG. 8.

FIG. 16 is a diagram for explaining an angle formed by a normal line to a convex light-exiting surface and a light beam emitted from one light-emitting point in a second light-emitting unit in the light-emitting module according to the first embodiment, the normal line passing through an intersection point at which the light beam and the convex light-exiting surface intersect each other.

FIG. 17 is a schematic top view of a light-emitting module for explaining a dark portion observed in the light-emitting module in a top view.

FIG. 18 is a diagram for explaining an angle formed by a tangent line to a first light incident surface and a plane parallel to a flat surface, the tangent line passing through an inflection point, and an angle formed by a tangent line to a second light incident surface and a plane parallel to the flat surface, the tangent line passing through the inflection point, in the light-emitting module according to the first embodiment.

FIG. 19 is a schematic perspective view of a lens according to a first modified example.

FIG. 20 is a schematic cross-sectional view taken along the line XX-XX in FIG. 19.

FIG. 21 is a schematic perspective view of a lens according to a second modified example.

FIG. 22 is a schematic cross-sectional view taken along the line XXII-XXII in FIG. 21.

FIG. 23 is a schematic top view illustrating an overall configuration of a light-emitting module according to a second embodiment.

FIG. 24 is a schematic cross-sectional view taken along the line XXIV-XXIV in FIG. 23.

FIG. 25 is a schematic perspective view illustrating the overall configuration of the light-emitting module according to the second embodiment.

FIG. 26 is a schematic cross-sectional view of a lens in the light-emitting module according to the second embodiment.

FIG. 27 is a schematic top view of a light-emitting module according to a third embodiment.

FIG. 28 is a schematic cross-sectional view taken along the line XXVIII-XXVIII in FIG. 27.

### DETAILED DESCRIPTION

Light-emitting modules and lenses according to embodiments of the present disclosure will be described in detail with reference to the accompanying drawings. However, the following embodiments are examples of light-emitting modules and lenses to embody the technical concept of the present embodiment, and the present disclosure is not limited to the embodiments described below. The dimensions, materials, shapes, relative arrangements, and the like of components described in the embodiments are not intended to limit the scope of the present disclosure, but are merely illustrative examples, unless otherwise specifically stated. The sizes, positional relationship, or the like of members illustrated in the drawings may be exaggerated for clarity of description. In the following description, members having the same terms and reference characters represent the same or similar members, and a detailed description of these members is omitted as appropriate. As a cross-sectional view, an end view illustrating only a cut surface may be used.

In the following drawings, directions may be indicated by an X-axis, a Y-axis, and a Z-axis corresponding to directions orthogonal to each other. An X direction along the X-axis and a Y direction along the Y-axis indicate directions along a light-emitting surface of a light-emitting unit in a light source included in the light-emitting module according to the embodiment. A Z direction along the Z-axis indicates a direction orthogonal to the light-emitting surface. In other words, the light-emitting surface of the light-emitting unit is parallel to an XY plane, and the Z-axis is orthogonal to the XY plane.

The direction the arrow points to in the X direction is the +X side, and the opposite side to the +X side is the −X side. The direction the arrow points to in the Y direction is the +Y side, and the opposite side to the +Y side is the −Y side. The direction the arrow points to in the Z direction is the +Z side, and the opposite side to the +Z side is the −Z side. In the embodiments, the light-emitting unit included in the light-emitting module emits light toward the +Z side as an example. However, these matters do not limit orientations of the light-emitting modules and the lenses according to the embodiments when the light-emitting modules and the lenses are used, and the light-emitting modules and the lenses according to the embodiments are in any orientation.

In the present specification, a surface of an object when viewed from the +Z side is referred to as an “upper surface,” and a surface of the object when viewed from the −Z side is referred to as a “lower surface.” In addition, the +Z side when viewed from the object may be referred to as an “upper side,” and the −Z side when viewed from the object may be referred to as a “lower side.” In this specification, “along the X-axis, Y-axis, or Z-axis” includes an object having an inclination within a range of +10° relative to the axis. In the present specification, “orthogonal” may include a tolerance within +10° with respect to 90°. In the present specification, “along” may include a tolerance within +10° with respect to 0°. Furthermore, “disposing” includes not only a case of disposing two objects in direct contact with each other but also includes a case of indirectly disposing, for example, disposing one object on the other object with another member provided therebetween. The “thickness” indicates a length of the object in the Z direction.

In the present specification or the claims, when a plurality of constituent components are provided and these constituent components are to be denoted individually, the constituent components may be distinguished by adding terms such as “first,” “second,” and the like in front of the terms of the constituent components. Objects to be distinguished may differ between the present specification and the claims.

### First Embodiment

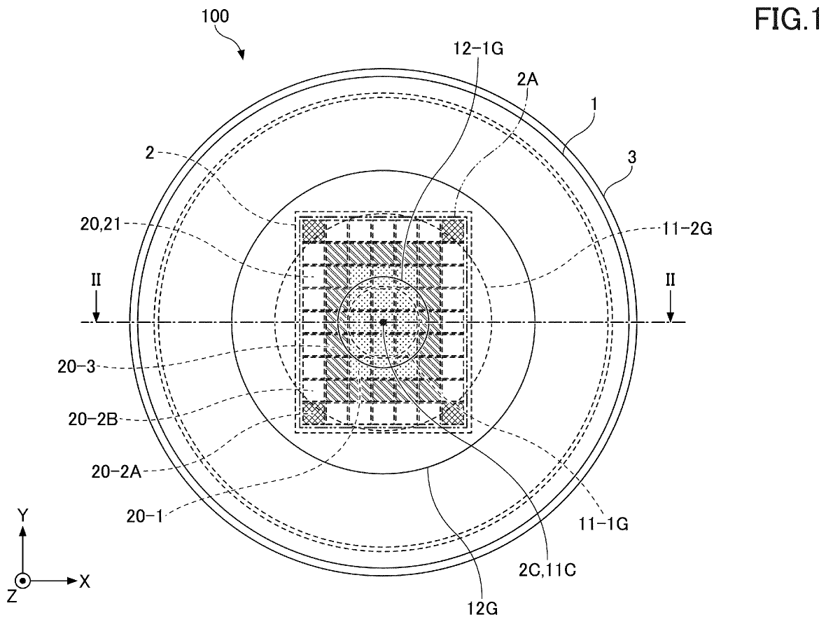

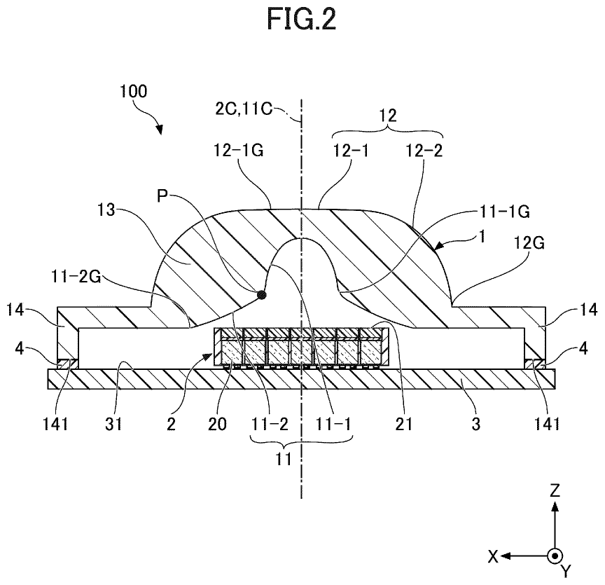

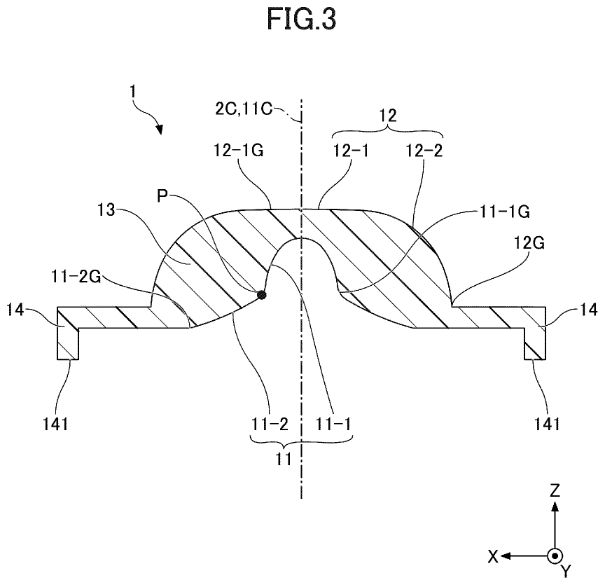

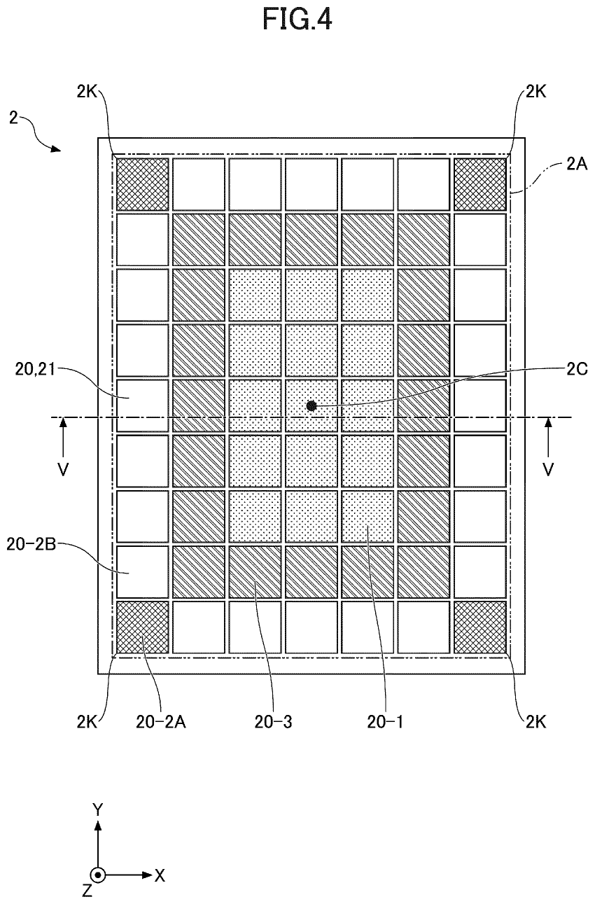

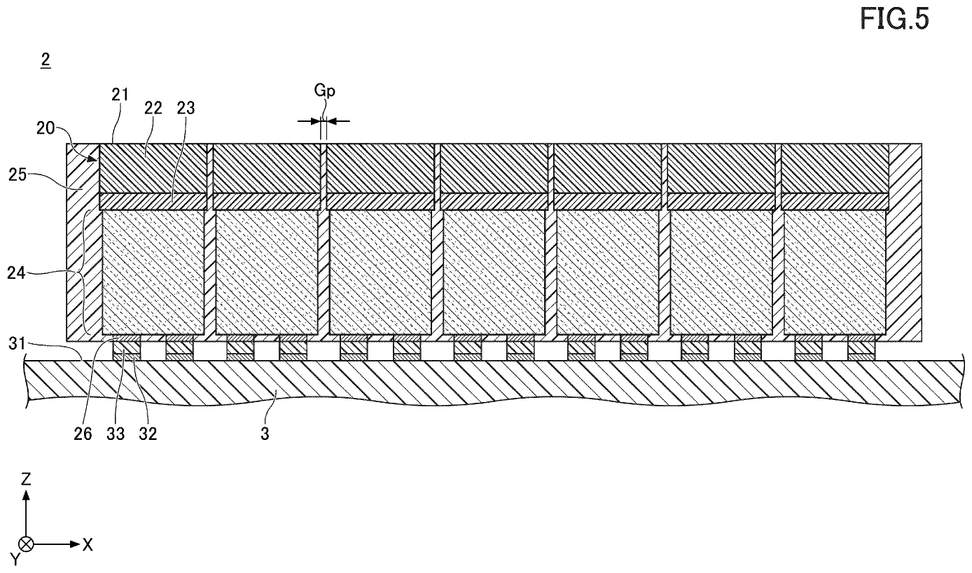

Configuration of Light-emitting Module according to First Embodiment A configuration of a light-emitting module according to a first embodiment is described with reference to FIGS. 1 to 5. FIG. 1 is a schematic top view illustrating the overall configuration of a light-emitting module 100 according to the first embodiment. FIG. 2 is a schematic cross-sectional view taken along the line II-II in FIG. 1. FIG. 3 is a schematic cross-sectional view illustrating the configuration of a lens 1 in the light-emitting module 100. FIG. 3 illustrates the cross section of the lens 1 corresponding to the line II-II in FIG. 1. FIG. 4 is a schematic top view illustrating the configuration of a light source 2 in the light-emitting module 100. FIG. 5 is a schematic cross-sectional view taken along the line V-V in FIG. 4.

The light-emitting module 100 is, as an example, a light-emitting module used in a flash light source of an imaging device mounted in a smartphone, or used in a flashlight/torch function and the like of a smartphone. Examples of the imaging device include a camera for imaging a still image and a video camera for imaging a moving image.

### Overall Configuration

As illustrated in FIGS. 1 and 2, the light-emitting module 100 includes the lens 1 having a light incident surface 11 that is concave upward and a light-exiting surface 12 that is located on the opposite side to the light incident surface 11, and the light source 2 having a plurality of light-emitting units 20 disposed below the lens 1.

In the example illustrated in FIGS. 1 and 2, the light-emitting module 100 includes a substrate 3 on which the lens 1 and the light source 2 are disposed, and a first adhesive member 4 bonding the lens 1 and the substrate 3. The light-emitting module 100, the lens 1, and the substrate 3 have a circular outer shape in a top view. In a top view, the outer shape of the substrate 3 is the outer shape of the light-emitting module 100. However, the outer shapes of the light-emitting module 100, the lens 1, and the substrate 3 are not limited to the circular shape in a top view, and may be other shapes such as an elliptical shape, a rectangular shape, or a polygonal shape.

As illustrated in FIGS. 2 and 3, in the present embodiment, the lens 1 includes the light incident surface 11 that is concave upward, and the light-exiting surface 12 located on the opposite side to the light incident surface 11. In the example illustrated in FIGS. 2 and 3, the lens 1 includes a light-transmissive portion 13 disposed above the light source 2, and a first support portion 14 located outside the light-transmissive portion 13 in a top view and supporting the light-transmissive portion 13. The light incident surface 11 includes the lower surface of the light-transmissive portion 13. The light-exiting surface 12 includes the upper surface and the lateral surface of the light-transmissive portion 13. The lateral surface of the light-transmissive portion 13 includes a curved surface. The lens 1 is bonded to an upper surface 31 of the substrate 3 with the first adhesive member 4 disposed between a lower surface 141 of the first support portion 14 and the upper surface 31 of the substrate 3.

In a cross section passing through a center line 11C of the light incident surface 11, the light incident surface 11 includes an inflection point P at which a concave surface changes to a convex surface, and a first light incident surface 11-1 that is located above the inflection point P, includes an upwardly concave surface continuous with the inflection point P, and is located in the central portion of the light incident surface 11 in a top view. The light incident surface 11 includes a second light incident surface 11-2 that is located below the inflection point P, includes a downwardly convex surface continuous with the inflection point P, and is located outside the first light incident surface 11-1 in a top view. The light-exiting surface 12 includes a flat surface 12-1 located on the opposite side to the first light incident surface 11-1, and a convex light-exiting surface 12-2 that is located outward of the flat surface 12-1 and convex upward in a top view. The inflection point P refers to a point of change from the upward convex to the downward convex and vice versa. The inflection point P can also be referred to as point at which the sign of the second derivative changes.

In the example illustrated in FIGS. 1 to 3, an outer edge 11-1G represents the outer edge of the first light incident surface 11-1. An outer edge 11-2G represents the outer edge of the second light incident surface 11-2. An outer edge 12G represents the outer edge of the light-exiting surface 12. The outer edge 12G of the light-exiting surface 12, the outer edge of the light-transmissive portion 13, and the outer edge of the convex light-exiting surface 12-2 overlap each other in a top view. The outer edge 12-1G represents the outer edge of the flat surface 12-1. In a top view, the first light incident surface 11-1 has a circular shape centered on the center line 11C, and the second light incident surface 11-2 has an annular shape centered on the center line 11C. In addition, in a top view, the flat surface 12-1 has a circular shape centered on the center line 11C, and the convex light-exiting surface 12-2 has an annular shape centered on the center line 11C. A light-source center line 2C represents the center line of the light source 2. The center line 11C represents the center line of the first light incident surface. The light-source center line 2C and the center line 11C overlap each other in a top view.

Here, in the light-emitting module, a lens suitable for variable light distribution is required. The lens suitable for variable light distribution can preferably change the light distribution of the light emitted from the light-emitting module, and in addition, for example, can preferably increase a central illuminance of the light emitted from the light-emitting module, and can preferably make the illuminance uniform. The central illuminance in the present specification can be regarded as the maximum illuminance in an irradiation region irradiated with light from the light-emitting module. The uniformity of illuminance can be expressed by “minimum illuminance in irradiation region÷maximum illuminance in irradiation region.”

For example, a light-emitting module, in which a biconvex lens having a light incident surface that is convex toward the light source side and a light-exiting surface that is convex toward the side opposite to the light source side is disposed above the light source, is required to increase the curvatures of the light incident surface and the light-exiting surface of the lens in order to increase the illuminance of the irradiation light. When the light incident surface has a large curvature, the amount of light having a large incident angle to the light incident surface, that is, the amount of light incident on the light incident surface at an angle nearly parallel to the light incident surface increases, and Fresnel reflection loss may increase. In addition, because the light incident surface or the light-exiting surface has a large curvature, and the absolute value of the refractive power of the biconvex lens is large, stray light that cannot be controlled by the lens increases in the light passing through the lens, and the light extraction efficiency of the light-emitting module may decrease. As a result, the absolute amount of light emitted from the light-emitting module is reduced, and it is difficult to increase the central illuminance. Furthermore, because the light incident surface and the light-exiting surface each have a large curvature, the incident angle of the light that enters the inside (light-transmissive portion) of the lens through the light incident surface and enters the light-exiting surface through the inside of the lens increases. This may increase the amount of light totally reflected by the light-exiting surface, and increase the light loss. This results in a reduction in the amount of light to be controlled in such a manner that the edges of the irradiation region are irradiated with light by the light-emitting module (particularly four corner portions of the irradiation region when it is rectangular), and it is therefore difficult to achieve uniform illuminance. The “refractive power” indicates a degree to which the traveling direction of incident light is changed. The “positive refractive power” is the refractive power to bend the light toward a converging direction. The “negative refractive power” is the refractive power to bend the light toward a diverging direction. The refractive power is not limited to being generated by refraction, and may be generated by an optical phenomenon other than refraction, such as diffraction or reflection.

In the present embodiment, the light incident on the first light incident surface 11-1 from the light source 2 is bent toward a direction in which the light diverges by the negative refractive power obtained by the first light incident surface 11-1 of the light incident surface 11 and the flat surface 12-1 of the light-exiting surface 12. This can cause the light to be used as light of wide-angle light distribution. The first light incident surface 11-1 is located above the inflection point P, includes a concave surface that is concave upward and is continuous with the inflection point, and is located in the central portion of the light incident surface 11 in a top view. Because the light in the vicinity of the light-source center line 2C of the light source 2 is incident on the first light incident surface 11-1, the light incident on the first light incident surface 11-1 is easily controlled, the light extraction efficiency is high, and both the Fresnel reflection loss on the light incident surface 11 and the light loss due to the total reflection on the light-exiting surface 12 are small. Accordingly, in the present embodiment, in the light of the wide-angle light distribution, the difference in luminous intensity depending on the light distribution angle of the light emitted from the light-emitting module 100 can be reduced, and the illuminance of the irradiation light can be made uniform. Further, in the present embodiment, part of the light from the light source 2 is refracted in a direction nearly perpendicular to the light-emitting surface of the light source 2 by the interaction between the second light incident surface 11-2 and the light-exiting surface 12, and therefore, the central illuminance of the light emitted from the light-emitting module 100 can be increased.

In the present embodiment, the light emitted from the light source 2 and incident on the second light incident surface 11-2 is bent toward a direction to which the light converges by the positive refractive power obtained by the second light incident surface 11-2 of the light incident surface 11 and the convex light-exiting surface 12-2 of the light-exiting surface 12. This can cause the light to be used as light of narrow-angle light distribution. In the lens 1, the second light incident surface 11-2 is located below the inflection point P, includes the convex surface that is convex downward and is continuous with the inflection point P, and is located outward of the first light incident surface 11-1 in a top view. Thus, the incident angle of the light incident on the second light incident surface 11-2 is smaller compared with a case in which the first light incident surface is present, extending without the inflection point. That is, the incident angle of the light incident on the second light incident surface 11-2 is nearly perpendicular to the second light incident surface 11-2. This can reduce Fresnel reflection loss. Further, in the lens 1, the light-exiting surface 12 includes the flat surface 12-1 located on the opposite side to the first light incident surface 11-1, and the convex light-exiting surface 12-2 that is located outward of the flat surface 12-1 in a top view and convex upward. Because the lens 1 includes the second light incident surface 11-2 and the light-exiting surface 12, the incident angle of light that enters the inside (specifically, the light-transmissive portion 13) of the lens 1 through the second light incident surface 11-2 and enters the light-exiting surface 12 through the inside of the lens 1 is smaller compared with a case in which the lens does not include the second light incident surface 11-2 and the light-exiting surface 12. This can reduce the light totally reflected by the light-exiting surface 12, and the light loss is reduced. As a result, in the present embodiment, the central illuminance of the light emitted from the light-emitting module 100 can be increased in the light of the narrow-angle light distribution.

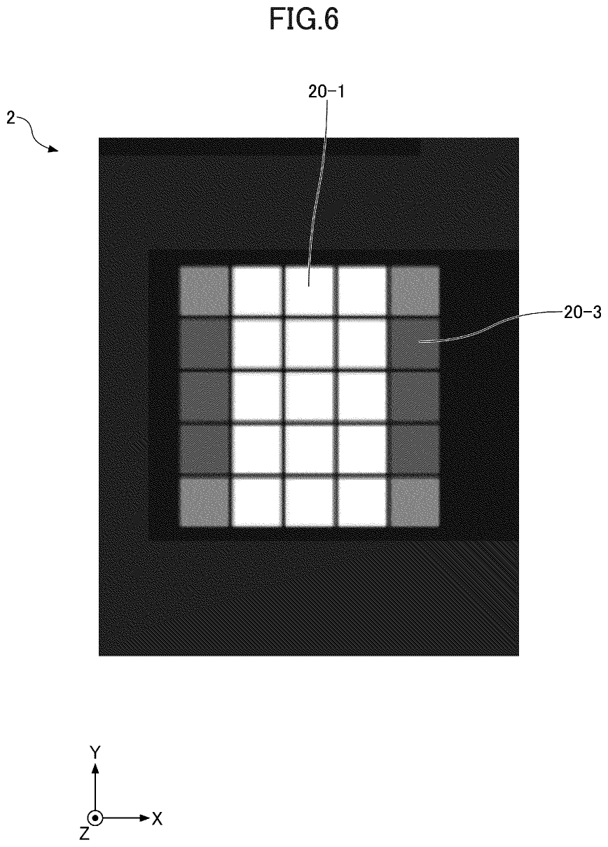

As described above, in the present embodiment, in both the wide-angle light distribution and the narrow-angle light distribution, the central illuminance of the light emitted from the light-emitting module 100 can be increased, and the illuminance of the irradiation light can be made uniform. Thus, in the present embodiment, the lens 1 and the light-emitting module 100 suitable for variable light distribution can be provided. The operational effects of the lens 1 will be described in more detail with reference to FIGS. 6 to 15.

The light source 2 is mounted on the upper surface 31 of the substrate 3. In the example illustrated in FIG. 1, the light source 2 has a rectangular outer shape in a top view. The light source 2 includes 63 light-emitting units 20 arranged in a matrix. In the 63 light-emitting units 20, seven light-emitting units 20 are aligned in a row direction (for example, the X direction), and nine light-emitting units 20 are aligned in a column direction (for example, the Y direction). However, the number of the light-emitting units 20 is not limited to 63, and can be determined as appropriate according to the specifications and the like of the light-emitting module 100.

In the example illustrated in FIGS. 1 and 4, the 63 light-emitting units 20 include 15 first light-emitting units 20-1 disposed in the central portion, and 28 second light-emitting units 20-2 disposed outward of the 15 first light-emitting units 20-1 in a top view. Among the second light-emitting units, four light-emitting units 20 arranged at four corner portions 2K of the rectangular light source 2 may be designated as second light-emitting units 20-2A, and the other light-emitting units 20 arranged along four sides of the rectangular light source 2 may be designated as second light-emitting units 20-2B to distinguish them from each other. The 63 light-emitting units 20 include 20 third light-emitting units 20-3 disposed between the 15 first light-emitting units 20-1 and the 28 second light-emitting units 20-2 in a top view. However, the number of first light-emitting units 20-1 is not limited to 15, and may be one or more. The number of second light-emitting units 20-2 is not limited to 28, and may be any number greater than one. In FIGS. 1 and 4, for the sake of easy understanding of the description, the first light-emitting units 20-1 are each indicated by a dotted pattern, the second light-emitting units 20-2A are each indicated by a cross grid pattern, the second light-emitting units 20-2B are each indicated without a pattern, and the third light-emitting units 20-3 are each indicated by a diagonal line pattern. At least one light-emitting unit 20 of the first light-emitting units 20-1, the second light-emitting units 20-2, and the third light-emitting units 20-3 is allowed to individually emit light or be turned off, or the light emission intensity thereof can be individually controlled.

As illustrated in FIG. 4, the plurality of light-emitting units 20 are arranged in a matrix, and the plurality of second light-emitting units 20-2 are located at the outermost periphery of the plurality of light-emitting units 20 in a top view. In the example illustrated in FIG. 4, the four second light-emitting units 20-2A are located at the outermost periphery among the 63 light-emitting units 20, and include the four corner portions 2K. The light-emitting module 100 can change the light distribution by switching between the wide-angle light distribution by lighting of the light-emitting units 20 including at least the first light-emitting units 20-1 and the narrow-angle light distribution by lighting of the light-emitting units 20 including at least the second light-emitting units 20-2 located at the outermost periphery. The plurality of light-emitting units 20 include at least the third light-emitting units 20-3 disposed between the first light-emitting units 20-1 located in the central portion and the second light-emitting units 20-2 located at the outermost periphery. Thus, as will be described later, the light-emitting module 100 can also switch to an intermediate light distribution that is intermediate between the wide-angle light distribution and the narrow-angle light distribution.

As illustrated in FIG. 1, one or more second light-emitting units 20-2 among the plurality of second light-emitting units 20-2 are disposed to overlap the second light incident surface 11-2 in a top view. The term “overlap” includes a case in which one is disposed inside the other and overlaps the other in a top view, and also includes a case in which one and the other partially overlap each other. In the example illustrated in FIG. 1, the four second light-emitting units 20-2A among the 28 second light-emitting units 20-2 are arranged to overlap the outer edge 11-2G of the second light incident surface 11-2 in a top view. One or more second light-emitting units 20-2 are disposed so as to overlap the second light incident surface 11-2 in a top view, so that the light emitted from the second light-emitting unit 20-2 is easily bent toward a direction to which the light converges by the positive refractive power obtained by the second light incident surface 11-2 and the convex light-exiting surface 12-2. As a result, it becomes easy to control the light entering the lens 1 from the light source 2 through the second light incident surface 11-2.

As illustrated in FIG. 1, in a top view, the flat surface 12-1 and one or more first light-emitting units 20-1 overlap, and the convex light-exiting surface 12-2 and one or more second light-emitting units 20-2 among the plurality of second light-emitting units 20-2 overlap. In the example illustrated in FIG. 1, in a top view, six first light-emitting units 20-1 overlap the outer edge 12-1G of the flat surface 12-1, and nine first light-emitting units 20-1 are located inside the outer edge 12-1G of the flat surface 12-1 and overlap the flat surface 12-1. In addition, the four second light-emitting units 20-2A are located inside the outer edge 12G (in other words, the outer edge of the convex light-exiting surface 12-2), and overlap the convex light-exiting surface 12-2 in a top view. In a top view, the flat surface 12-1 and the one or more first light-emitting units 20-1 overlap each other, and the convex light-exiting surface 12-2 and the one or more second light-emitting units 20-2 overlap each other, so that the light distribution can be switched by the light emission control for the first light-emitting units 20-1 and the second light-emitting units 20-2. The light emission control for the first light-emitting unit 20-1 and the second light-emitting unit 20-2 includes causing at least one of the first light-emitting unit 20-1 or the second light-emitting unit 20-2 to emit light or to be turned off, or controlling the light emission intensity of at least one of the first light-emitting unit 20-1 or the second light-emitting unit 20-2.

In the example illustrated in FIGS. 1 and 4, a light-emitting surface 21 refers to a main light extraction surface of the light-emitting unit 20. Therefore, the light-emitting surface 21 of the light-emitting unit 20 also serves as a light-emitting surface of the light source 2. In FIGS. 1 and 4, the reference characters of the light-emitting unit 20 and the light-emitting surface 21 are additionally written to indicate that the light-emitting unit 20 and the light-emitting surface 21 overlap each other in a top view. Also in the following drawings, reference characters may be additionally written for the same purpose.

The light-emitting surface of the light source 2 includes a light-emitting region 2A. The light-emitting region 2A is a region defined by connecting outer edges of the light-emitting surfaces 21 of the plurality of light-emitting units 20 located on the outer side in a top view. In the example illustrated in FIG. 4, the light-emitting region 2A includes 63 light-emitting surfaces 21, and the outer shape of the light-emitting region 2A is a rectangular shape in a top view. The light-emitting region 2A includes the four corner portions 2K. In a top view, the light-source center line 2C of the light source 2 overlaps the center of the light-emitting region 2A. The outer shape of the light source 2 is not limited to a rectangular shape in a top view, and may be another shape such as a circular shape, an elliptical shape, or a polygonal shape.

The 63 light-emitting units 20 can be individually driven. That is, each of the 63 light-emitting units 20 in the light source 2 may be individually driven, or a plurality of groups into which the 63 light-emitting units 20 are divided can be individually driven. The 63 light-emitting units 20 can emit light toward the lens 1 provided above the light source 2. In the light-emitting module 100, the distribution of the current to be supplied to each of the 63 light-emitting units 20 can be controlled, and thus the light distribution of the light emitted from the light-emitting module 100 can be controlled.

In the light-emitting module 100, each of the 63 light-emitting units 20 can individually be turned on, or each of the groups can be turned on, to emit light with desired brightness. This can increase the contrast of the irradiation light on the irradiation plane irradiated with the light from the light source 2. In addition, the light-emitting module 100 can partially irradiate the irradiation plane with light by individually turning on each of the 63 light-emitting units 20 or by turning on each of the groups. The phrase “partially irradiate” refers to irradiating a part of the region of the irradiation plane with light.

When the light-emitting module 100 is used as a flash light source of an imaging device, for example, the light-emitting module 100 can switch the mode of light to be emitted from the light-emitting module 100 between a wide-angle mode, a narrow-angle mode, and an intermediate mode. The wide-angle mode is a mode that causes mainly the first light-emitting units 20-1 to emit light. The light emitted from the light-emitting module 100 in the wide-angle mode has a wide-angle light distribution. The narrow-angle mode is a mode that causes mainly the second light-emitting units 20-2 to emit light. The light emitted from the light-emitting module 100 in the narrow-angle mode has a narrow-angle light distribution. That is, the light distribution angle in the narrow-angle mode is smaller than that in the wide-angle mode. The intermediate mode is a mode that causes mainly the third light-emitting units 20-3 to emit light. The light emitted from the light-emitting module 100 in the intermediate mode has an intermediate light distribution between the narrow-angle light distribution and the wide-angle light distribution. That is, the light distribution angle in the intermediate mode is greater than that in the narrow-angle mode, and is smaller than that in the wide-angle mode. The light-emitting module 100 can also emit light by switching between the wide-angle light distribution, the narrow-angle light distribution, and the intermediate light distribution by adjusting the intensity of light of each of the first light-emitting unit 20-1, the second light-emitting unit 20-2, and the third light-emitting unit 20-3.

Because the light-emitting module 100 can switch the mode of irradiation light according to the wide-angle mode, the narrow-angle mode, and the intermediate mode, for example, imaging can be performed with an imaging device according to an imaging mode such as close-up mode or telephoto mode by using light emitted from the light-emitting module 100. In addition, in the case in which the light-emitting module 100 is used as a light source for a flashlight/torch of a smartphone, the light emitted from light-emitting module 100 is set to a narrow-angle mode, so that the irradiation light can reach a long distance, and the performance of the flashlight/torch can be enhanced.

Each component of the light-emitting module 100 will be described in detail below.

### Lens 1

The lens 1 includes at least one of a resin material, such as a polycarbonate resin, an acrylic resin, a silicone resin, or an epoxy resin, or a glass material, these materials having transmissivity to the light emitted from the light source 2. In the example illustrated in FIGS. 2 and 3, the light-transmissive portion 13 and the first support portion 14 are connected to each other as an integrated member. However, the light-transmissive portion 13 and the first support portion 14 may be structured by individual members. In addition, the first support portion 14 may be omitted, and the light-transmissive portion 13 may also serve as the first support portion 14. The term “transmissivity” in the lens 1 refers to a property that allows 60% or more of light emitted from the light source 2 to be transmitted.

In the example illustrated in FIG. 1, the light-exiting surface 12 has a circular outer shape in a top view. However, the outer shape of the light-exiting surface 12 is not limited to a circular shape, and may be another outer shape such as a rectangular shape, an elliptical shape, or a polygonal shape in a top view. Further, the light-exiting surface 12 may have a rotationally symmetrical shape in a top view. In consideration of the fact that an imaging range of a general imaging device is rectangular, the light-exiting surface 12 preferably has a four-fold rotationally symmetrical shape or a two-fold rotationally symmetrical shape in a top view.

The flat surface 12-1 has a circular outer shape in a top view. However, the outer shape of the flat surface 12-1 is not limited to a circular shape, and may be a rectangular, an elliptical, a polygonal or other outer shape in a top view. The convex light-exiting surface 12-2 is located outside the flat surface 12-1, and has a circular annular shape centered on the center line 11C in a top view. However, the shape of the convex light-exiting surface 12-2 is not limited to a circular shape, and may be an annular shape such as a rectangular shape, an elliptical shape, or a polygonal shape in a top view.

The first support portion 14 supports the light-transmissive portion 13 from the outside in a top view. In addition, the first support portion 14 has a circular annular shape centered on the center line 11C in a top view. However, the shape of the first support portion 14 in a top view is not limited to a circular shape, and may be an annular shape such as a rectangular shape, an elliptical shape, or a polygonal shape. In addition, the first support portion 14 may include a plurality of first support portions 14, and the plurality of first support portions 14 may be disposed in a discontinuous annular shape in a top view.

In the example illustrated in FIGS. 2 and 3, the first light incident surface 11-1 has an aspherical shape that is concave upward. However, the first light incident surface 11-1 may have a spherical shape that is concave upward. The second light incident surface 11-2 has a circular annular shape centered on the center line 11C in a top view. However, the shape of the second light incident surface 11-2 in a top view is not limited to a circular shape, and may be an annular shape such as a rectangular shape, an elliptical shape, or a polygonal shape. The second light incident surface 11-2 has an aspherical shape that is convex downward in a cross section passing through the center line 11C of the light incident surface 11. The flat surface 12-1 is a flat surface parallel to the upper surface 31 of the substrate 3.

### Light Source 2

The light source 2 will be described in detail with reference to FIGS. 4 and 5. In FIG. 4, to avoid complication of the drawing, the light-emitting unit 20 disposed in the fifth row, the first column of the 63 light-emitting units 20 and the light-emitting surface 21 are only denoted by reference characters. Similarly, in FIG. 5, to avoid complication of the drawing, the light-emitting unit 20 corresponding to the light-emitting unit 20 disposed in the fifth row, the first column in FIG. 4 is only denoted by a reference character.

The light source 2 includes, on its upper surface, the light-emitting surface 21 of the light-emitting unit 20 in the upper surface, and is disposed on the upper surface 31 of the substrate 3, for example, on a +Z side surface of the substrate 3 with a surface of the light source 2 opposite to the light-emitting surface 21 used as a mounting surface. The 63 light-emitting units 20 in the light source 2 have the substantially same configuration. Therefore, the configuration of the light-emitting unit 20 disposed in the fifth row, the first column may be described below as a representative example.

In the example illustrated in FIG. 5, the light-emitting unit 20 includes a light-emitting element 24, a wavelength conversion member 23 disposed on the light-emitting element 24, a light diffusion member 22 disposed on the wavelength conversion member 23. Further, the light-emitting unit 20 includes a covering member 25 covering the respective lateral surfaces of the light diffusion member 22, the wavelength conversion member 23, and the light-emitting element 24, and electrodes 26 disposed on a surface (that is a lower surface) opposite to the light-emitting surface 21.

The light-emitting element 24 is disposed on wirings 32 of the substrate 3 with the electrodes 26 and electrically conductive members 33 interposed therebetween. The lateral surfaces of the electrodes 26 and the lower surface of the light-emitting element 24 are covered with the covering member 25.

The covering member 25 integrally holds a plurality of light diffusion members 22, a plurality of wavelength conversion members 23, and a plurality of light-emitting elements 24. From another view point, the plurality of light-emitting units 20 are integrally held by the covering member 25. The term “integrally” means a state in which the components are integrated into one and cannot be separated. Because the plurality of light-emitting units 20 are integrally held by the covering member 25, the area of the light-emitting region 2A of the light source 2 in a top view can be reduced as compared with the case in which the covering members of the plurality of light-emitting units are separated from each other. Thus the lens 1 disposed above the light source 2 can be reduced in size.

In the example illustrated in FIG. 5, the covering member 25 is disposed on the lateral surfaces of the light diffusion members 22, the wavelength conversion members 23, and the light-emitting elements 24. The covering member 25 is disposed between adjacent light diffusion members 22, between the adjacent wavelength conversion members 23, and between adjacent light-emitting elements 24. The covering member 25 integrally holds the light diffusion member 22, the wavelength conversion member 23, and the light-emitting element 24 included in each of the 63 light-emitting units 20. An upper surface of the covering member 25 forms a part of the upper surface of the light source 2. In addition, the covering member 25 includes two long lateral surfaces and two short lateral surfaces, and the four lateral surfaces form the rectangular outer shape of the light source 2 in a top view.

The light source 2 includes the plurality of light-emitting units 20, which increases the degree of freedom in the pattern of light that can be emitted from the light source 2. The covering member 25 integrally holds the plurality of light diffusion members 22, the plurality of wavelength conversion members 23, and the plurality of light-emitting elements 24, so that the light source 2 can be easily mounted.

The light-emitting element 24 includes various semiconductors including a group III-V compound semiconductor and a group II-VI compound semiconductor, and the like. As the semiconductor, preferably, a nitride-based semiconductor such as In_{X}Al_{Y}Ga_{1-X-Y}N (0≤X, 0≤Y, X+Y≤1) is used, and any of InN, AlN, GaN, InGaN, AlGaN, InGaAlN, and the like can also be used. The light-emitting element 24 is an LED or a laser diode (LD), for example. The nitride-based semiconductor of the light-emitting element 24 is provided on a growth substrate such as sapphire. The light-emitting element 24 may be obtained by forming a nitride-based semiconductor on the growth substrate and then removing the growth substrate. A light emission peak wavelength of the light-emitting element 24 is preferably in a range of 400 nm to 530 nm, more preferably in a range of 420 nm to 490 nm, even more preferably in a range of 450 nm to 475 nm from the viewpoints of light emission efficiency, excitation of a wavelength conversion substance described below, and the like.

The wavelength conversion member 23 is, for example, a member having a rectangular shape in a top view. The wavelength conversion member 23 is provided so as to cover an upper surface of the light-emitting element 24. The wavelength conversion member 23 contains a wavelength conversion substance that converts a wavelength of at least part of light from the light-emitting element 24. The wavelength conversion member 23 can be formed using a light-transmissive resin material or an inorganic material such as ceramics or glass. As the resin material, a thermosetting resin, such as a silicone resin, a silicone modified resin, an epoxy resin, an epoxy modified resin, or a phenol resin, can be used. Particularly, a silicone resin or a modified resin thereof with high light resistance and heat resistance is used. The term “light-transmissive” here preferably refers to transmission of 60% or more of the light from the light-emitting element 24. In addition, the wavelength conversion member 23 may use a thermoplastic resin, such as a polycarbonate resin, an acrylic resin, a methyl pentene resin, or a polynorbornene resin. The wavelength conversion member 23 may be, for example, a member containing a wavelength conversion substance in a resin material, ceramics, glass, or the like, and a sintered body of the wavelength conversion substance. Further, the wavelength conversion member 23 may contain a light diffusion substance described below in the resin described above. In addition, the wavelength conversion member 23 may also be a multilayer member in which a resin layer containing the wavelength conversion substance or the light diffusion substance is disposed on a +Z side surface of a molded body of resin, ceramics, glass, or the like.

As the wavelength conversion substance contained in the wavelength conversion member 23, an yttrium aluminum garnet-based phosphor (for example, (Y,Gd)₃(Al, Ga)₅O₁₂:Ce), a lutetium aluminum garnet-based phosphor (for example, Lu₃(Al, Ga)₅O₁₂:Ce), a terbium aluminum garnet-based phosphor (for example, Tb₃(Al, Ga)₅O₁₂:Ce), a CCA-based phosphor (for example, Ca₁₀(PO₄)₆Cl₂:Eu), an SAE-based phosphor (for example, Sr₄Al₁₄O₂₅:Eu), a chlorosilicate-based phosphor (for example, Ca₈MgSi₄O₁₆Cl₂:Eu), a silicate-based phosphor (for example, (Ba, Sr, Ca, Mg)₂SiO₄:Eu), an oxynitride-based phosphor such as a β-SiAlON-based phosphor (for example, (Si, Al)₃(O, N)₄:Eu) or an α-SiAlON-based phosphor (for example, Ca(Si, Al)₁₂(O, N)₁₆:Eu), a nitride-based phosphor such as an LSN-based phosphor (for example, (La, Y)₃Si₆N₁₁:Ce), a BSESN-based phosphor (for example, (Ba, Sr)₂Si₅N₈:Eu), an SLA-based phosphor (for example, SrLiAl₃N₄:Eu), a CASN-based phosphor (for example, CaAlSiN₃:Eu), or an SCASN-based phosphor (for example, (Sr, Ca)AlSiN₃:Eu), a fluoride-based phosphor such as a KSF-based phosphor (for example, K₂SiF₆:Mn), a KSAF-based phosphor (for example, K₂(Si₁₋ₓ Alₓ)F₆₋ₓ:Mn, where x satisfies 0<x<1), or an MGF-based phosphor (for example, 3.5MgO·0.5MgF₂·GeO₂:Mn), a quantum dot having a perovskite structure (for example, (Cs,FA,MA)(Pb,Sn)(F,Cl,Br,I)₃, where FA and MA represent formamidinium and methylammonium, respectively), a group II-VI quantum dot (for example, CdSe), a group III-V quantum dot (for example, InP), a quantum dot having a chalcopyrite structure (for example, (Ag,Cu)(In,Ga)(S,Se)₂), or the like can be used. The wavelength conversion substance described above is in the form of particles. Further, one of these types of wavelength conversion substance can be used alone, or two or more of these types of wavelength conversion substance can be used in combination.

Because the light-emitting unit 20 includes the light-emitting element 24 and the wavelength conversion member 23, the light-emitting unit 20 can emit mixed-color light including a color of light emitted from the light-emitting element 24 and a color of light emitted from the wavelength conversion member 23. In the light-emitting unit 20, a degree of freedom in a color of light emitted from the light-emitting unit 20 is increased by a combination of the light-emitting element 24 and the wavelength conversion member 23.

In the present embodiment, the light-emitting unit 20 uses a blue LED as the light-emitting element 24, and the wavelength conversion member 23 contains a wavelength conversion substance for converting the wavelength of the light emitted from the light-emitting element 24 into that of yellow light. Thus, the light source 2 including the light-emitting unit 20 emits white light. The wavelength or chromaticity of light emitted from the light source 2 may be appropriately selected according to the intended use of the light-emitting module 100.

The light diffusion member 22 is a member that diffuses light from the light-emitting element 24 and the wavelength conversion member 23, and is, for example, a member having a rectangular shape in a top view. In the light diffusion member 22, the same or a similar resin material as that of the wavelength conversion member 23 is used as a base material, and for example, titanium oxide, barium titanate, aluminum oxide, or silicon oxide can be contained as a light diffusion substance. An upper surface of the light diffusion member 22 in the example illustrated in FIG. 5 is exposed from the covering member 25 and corresponds to the light-emitting surface 21 of the light-emitting unit 20.

The covering member 25 directly or indirectly covers the lateral surfaces of the light diffusion members 22, the wavelength conversion members 23, and the light-emitting elements 24. The covering member 25 is preferably formed of a member having high light reflectivity. Covering the light diffusion members 22, the wavelength conversion members 23, and the light-emitting elements 24 with the covering member 25 can reduce light leaking from these members, and light can be efficiently extracted from the light-emitting surface 21. This can increase light extraction efficiency of the light-emitting unit 20. For the covering member 25, a resin material containing a light diffusion substance, such as white pigment, for example, can be used. Alternatively, the covering member 25 may be a light-reflective member formed of an inorganic material containing boron nitride and alkali metal silicate, for example. In this case, titanium oxide or zirconium oxide can be further contained.

Examples of the light diffusion substance contained in the covering member 25 include titanium oxide, zinc oxide, magnesium oxide, magnesium carbonate, magnesium hydroxide, calcium carbonate, calcium hydroxide, calcium silicate, magnesium silicate, barium titanate, barium sulfate, aluminum hydroxide, aluminum oxide, zirconium oxide, and silicon oxide. One of these types of substance is preferably used alone, or a combination of two or more of these types of substance is preferably used. For the resin material, a resin material containing a thermosetting resin, such as an epoxy resin, an epoxy modified resin, a silicone resin, a silicone modified resin, or a phenol resin, as a main component is preferably used as a base material. The covering member 25 may be constituted by a member having transmissivity or absorbance for visible light as necessary. The member having light absorbance contains, for example, carbon black.

In the example illustrated in FIGS. 4 and 5, in the light source 2, a gap Gp between the adjacent light-emitting surfaces 21 is, for example, in a range of 10 μm to 50 μm.

The light source 2 is electrically connected to the wirings 32 included in the substrate 3. The substrate 3 includes the wirings 32 disposed on a surface. The substrate 3 may include the wirings 32 therein. The light source 2 and the substrate 3 are electrically connected to each other by connecting the wirings 32 of the substrate 3 and the electrodes 26 of the light-emitting element 24 to each other via the electrically conductive members 33. The configuration, size, and the like of the wirings 32 of the substrate 3 are set according to the configuration and size of the electrode 26 of the light-emitting element 24.

### Substrate 3

The substrate 3 includes a wiring, on which the light source 2 can be mounted. An electronic component other than the light source 2 may be further disposed on the substrate 3. The electronic component is a Zener diode, a thermistor, a capacitor, a light-receiving sensor, or the like.

It is preferable that the substrate 3 uses an insulation material as a base material, and also uses a material that is less likely to transmit light emitted from the light source 2, light incident into the light-emitting module 100 from outside, or the like. Further, for the substrate 3, a material having a certain degree of strength is preferably used. Specifically, the substrate 3 can be formed using a ceramic, such as alumina, aluminum nitride, mullite, or silicon nitride, or a resin, such as a phenol resin, an epoxy resin, a polyimide resin, a bismaleimide triazine resin (BT resin), a polyphthalamide, or a polyester resin, as the base material.

The wirings 32 of the substrate 3 can be formed of at least one type of copper, iron, nickel, tungsten, chromium, aluminum, silver, gold, titanium, palladium, rhodium, an alloy thereof, or the like. Furthermore, a layer of silver, platinum, aluminum, rhodium, gold, an alloy thereof, or the like may be provided on the surface layer of the wirings 32 of the substrate 3, from the view point of at least one of the wettability or light reflectivity of the electrically conductive member.

### Operational Effects of Light-Emitting Module 100

A behavior of light in the wide-angle mode, the narrow-angle mode, and the intermediate mode in the light-emitting module 100, and operational effects of the light-emitting module 100 will be described with reference to FIGS. 6 to 15.

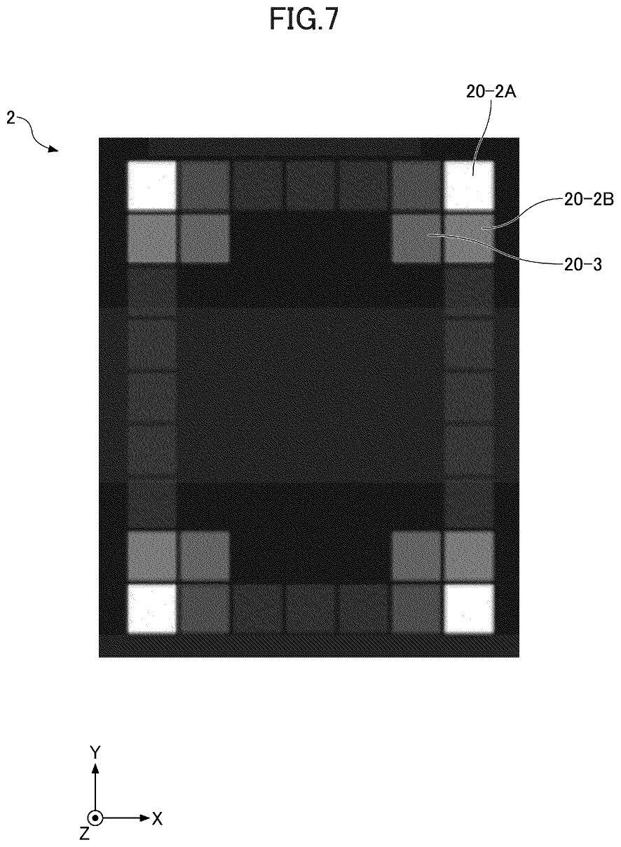

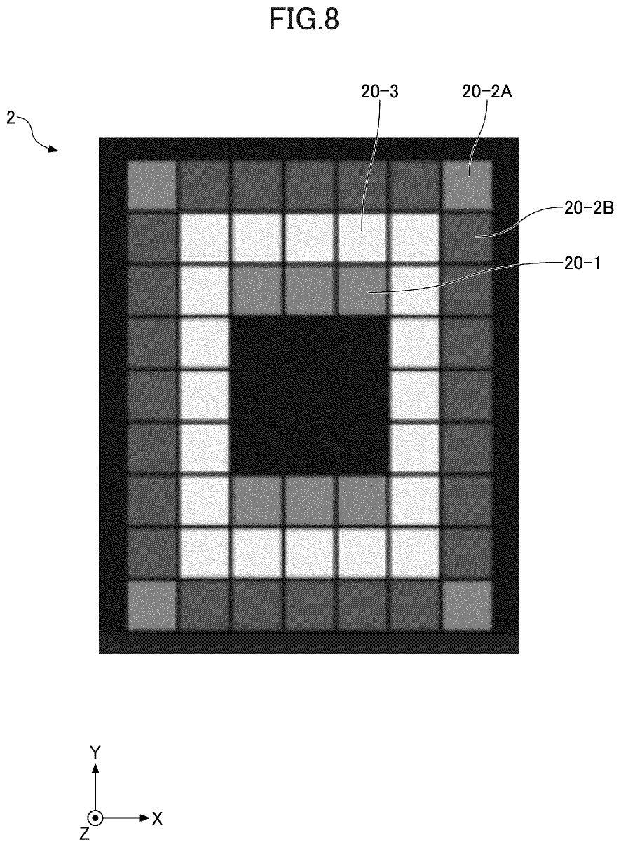

FIG. 6 is a schematic view illustrating an example of a light emission pattern of the light source 2 in the wide-angle mode. FIG. 7 is a schematic view illustrating an example of a light emission pattern of the light source 2 in the narrow-angle mode. FIG. 8 is a schematic view illustrating an example of a light emission pattern of the light source 2 in the intermediate mode. FIGS. 6 to 8 illustrate the light source 2 when viewed from the +Z side. In FIGS. 6 to 8, the light emission intensity of the light-emitting unit 20 is indicated with the color of the light-emitting unit 20 in the drawings. The white, light gray, and dark gray light-emitting units 20 indicate that they are emitting light, and the black light-emitting unit 20 indicates that it is not emitting light. The light-emitting unit 20 having a lighter color among white, light gray, and dark gray colors has a higher light emission intensity. Therefore, the light emission intensity of the white light-emitting unit 20 is the highest.

In the wide-angle mode indicated in FIG. 6, the first light-emitting units 20-1 and the third light-emitting units 20-3 emit light. The light emission intensity of the first light-emitting unit 20-1 is higher than the light emission intensity of the third light-emitting unit 20-3. As described above, in the wide-angle mode, it is preferable to cause one or more light-emitting units 20 in the vicinity of the first light-emitting units 20-1, in addition to the first light-emitting units 20-1, to emit light at a light emission intensity lower than that of the first light-emitting units 20-1. However, in the wide-angle mode, only the first light-emitting units 20-1 may be caused to emit light.

In the narrow-angle mode indicated in FIG. 7, the second light-emitting units 20-2 and the third light-emitting units 20-3 emit light. The light emission intensity of the second light-emitting unit 20-2 (particularly, the second light-emitting unit 20-2A) is higher than the light emission intensity of the third light-emitting unit 20-3. As described above, in the narrow-angle mode, it is preferable to cause one or more light-emitting units 20 in the vicinity of the second light-emitting units 20-2, in addition to the second light-emitting units 20-2, to emit light at a light emission intensity lower than that of the second light-emitting units 20-2. However, in the narrow-angle mode, only the second light-emitting units 20-2 may be caused to emit light.

In the intermediate mode indicated in FIG. 8, the first light-emitting units 20-1, the second light-emitting units 20-2, and the third light-emitting units 20-3 emit light. The light emission intensity of the third light-emitting units 20-3 is higher than the light emission intensities of the first light-emitting units 20-1 and the second light-emitting units 20-2. As described above, in the intermediate mode, it is preferable to cause one or more light-emitting units 20 in the vicinity of the third light-emitting units 20-3, in addition to the third light-emitting units 20-3, to emit light at a light emission intensity lower than that of the third light-emitting units 20-3. However, in the intermediate mode, only the third light-emitting units 20-3 may be caused to emit light.

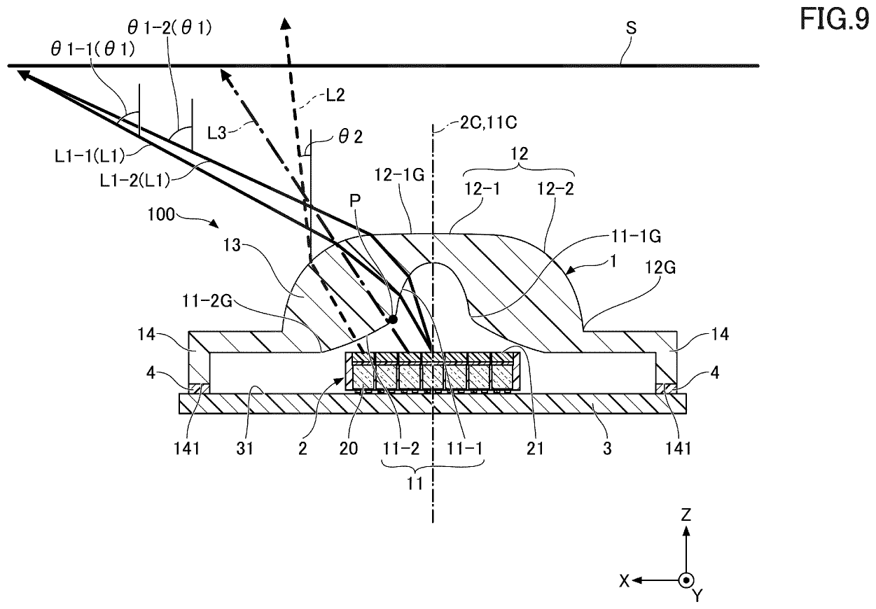

FIG. 9 is a schematic cross-sectional view of the light-emitting module 100, illustrating the behavior of light emitted from the light source 2. FIG. 9 illustrates a cross section corresponding to the line II-II in FIG. 1. FIG. 9 illustrates some of light beams emitted from the light-emitting unit 20 of the light source 2 with arrows. Light L1 is light emitted from the first light-emitting unit 20-1 in the wide-angle mode. In the present embodiment, one or more first light-emitting units 20-1 emit light. Light L2 is light emitted from the second light-emitting unit 20-2 in the narrow-angle mode. In the present embodiment, the plurality of second light-emitting units 20-2 including the four second light-emitting units 20-2A emit light. Light L3 is light emitted from the third light-emitting unit 20-3 in the intermediate mode. In the present embodiment, the plurality of third light-emitting units 20-3 emit light. An irradiation plane S is a plane irradiated with light from the light-emitting module 100.

As illustrated in FIG. 9, the light-emitting module 100 can emit the light L1 having a first light distribution angle θ1 and having passed through the lens 1 when only one or more first light-emitting units 20-1 are caused to emit light, and can emit the light L2 having a second light distribution angle θ2 and having passed through the lens 1 when only the plurality of second light-emitting units 20-2 are caused to emit light. The first light distribution angle θ1 is greater than the second light distribution angle θ2.

In the wide-angle mode, the light L1 emitted from the first light-emitting unit 20-1 enters the light-transmissive portion 13 of the lens 1 through the first light incident surface 11-1, passes through the light-transmissive portion 13 of the lens 1, and then exits from the lens 1 through the convex light-exiting surface 12-2 (light L1-1 in FIG. 9). The light L1 is bent in the diverging direction by the negative refractive power obtained by the first light incident surface 11-1 of the light incident surface 11 and the flat surface 12-1 of the light-exiting surface 12 (light L1-2 in FIG. 9). The light L1 is light having the wide-angle light distribution and traveling in a direction opposite to the direction in which the center line 11C of the light incident surface 11 is located.

In the narrow-angle mode, the light L2 emitted from the second light-emitting unit 20-2 enters the light-transmissive portion 13 of the lens 1 through the second light incident surface 11-2, passes through the light-transmissive portion 13 of the lens 1, and then exits from the lens 1 through the convex light-exiting surface 12-2. The light L2 is bent in the converging direction by the positive refractive power obtained by the second light incident surface 11-2 of the light incident surface 11 and the convex light-exiting surface 12-2 of the light-exiting surface 12. The light L2 is light having the narrow-angle light distribution and traveling in a direction extending in the center line 11C of the light incident surface 11.

In the intermediate mode, the light L3 emitted from the third light-emitting unit 20-3 enters the light-transmissive portion 13 of the lens 1 through the second light incident surface 11-2, passes through the light-transmissive portion 13 of the lens 1, and then exits from the lens 1 through the convex light-exiting surface 12-2. The light L3 is light having the intermediate light distribution and traveling in a direction intermediate between the traveling direction of the light L1 and the traveling direction of the light L2.

In the present embodiment, the light L1 can be used as light of the wide-angle light distribution by bending the light L1 in the diverging direction. The first light incident surface 11-1 is located above the inflection point P, includes a concave surface that is concave upward and is continuous with the inflection point P, and is located in the central portion of the light incident surface 11 in a top view. The light L1 from the vicinity of the light-source center line 2C in the light source 2 enters the first light incident surface 11-1. Therefore, the light L1 incident on the first light incident surface 11-1 is easily controlled, the light extraction efficiency is high, and both the Fresnel reflection loss on the light incident surface 11 and the light loss due to the total reflection on the light-exiting surface 12 are small. Accordingly, in the present embodiment, in the wide-angle mode, the central illuminance of the light emitted from the light-emitting module 100 can be increased, and the difference in luminous intensity depending on the light distribution angle can be reduced, so that the illuminance of the irradiation light can be made uniform.

In the present embodiment, the light L2 can be used as light of the narrow-angle light distribution by bending the light L2 in the converging direction. Further, because the second light incident surface 11-2 is located below the inflection point P, includes the convex surface that is convex downward and continuous with the inflection point P, and is located outward of the first light incident surface 11-1 in a top view, the incident angle of the light L2 on the second light incident surface 11-2 is smaller as compared with a light incident surface having no inflection point. This can reduce the Fresnel reflection loss. Further, in the lens 1, the light-exiting surface 12 includes the flat surface 12-1 located on the opposite side to the first light incident surface 11-1, and the convex light-exiting surface 12-2 that is located outward of the flat surface 12-1 in a top view and convex upward. Because the lens 1 includes the second light incident surface 11-2 and the light-exiting surface 12, the incident angle of the light L2 that enters the light-transmissive portion 13 of the lens 1 through the second light incident surface 11-2 and enters the light-exiting surface 12 through the light-transmissive portion 13 of the lens 1 is smaller compared with a case in which the lens does not include the second light incident surface 11-2 and the light-exiting surface 12. This can reduce the light loss caused by the light L2 being totally reflected by the light-exiting surface 12. As a result, in the present embodiment, in the narrow-angle mode, the central illuminance of the light emitted from the light-emitting module 100 can be increased, and the difference in luminous intensity depending on the light distribution angle can be reduced, so that the illuminance of the irradiation light can be made uniform.

In the light-emitting module 100, the light L3 can be used as light of the intermediate light distribution. Because the light L3 enters the light-transmissive portion 13 of the lens 1 through the vicinity of the inflection point P on the light incident surface 11, the incident angle to the light incident surface 11 is small, and the Fresnel reflection loss is small. The light L3 passes through the vicinity of the inflection point P on the light incident surface 11, enters the light-transmissive portion 13 of the lens 1, passes through the vicinity of the center of the convex light-exiting surface 12-2, and exits from the light-exiting surface 12. Therefore, the light L3 is easily controlled and has high light extraction efficiency. Further, because the incident angle of the light L3 incident on the light-exiting surface 12 from the light-transmissive portion 13 of the lens 1 is small, the light loss caused by the light L3 being totally reflected by the light-exiting surface 12 can be reduced. As a result, in the intermediate mode in the light-emitting module 100, the central illuminance of the light emitted from the light-emitting module 100 can be increased, the difference in luminous intensity depending on the light distribution angle can be reduced, so that the illuminance of the irradiation light can be made uniform.

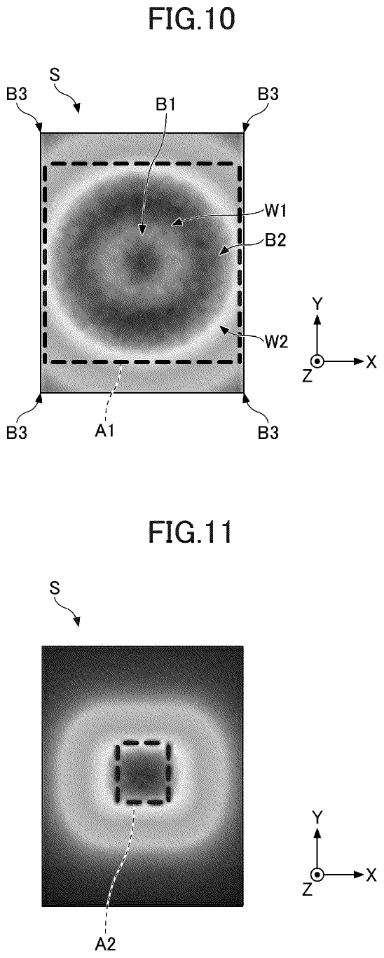

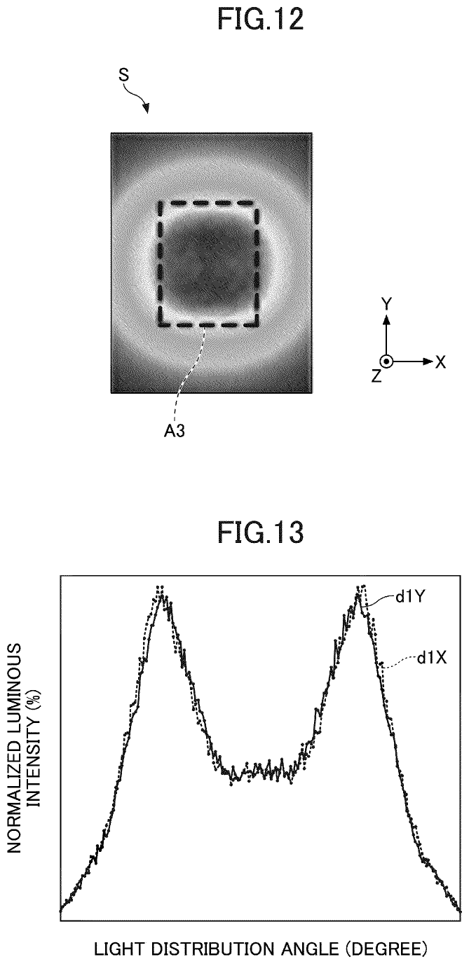

FIG. 10 is a diagram illustrating a simulation result of an illuminance distribution on the irradiation plane S in the light emission pattern of FIG. 6, that is, in the wide-angle mode. FIG. 11 is a diagram illustrating a simulation result of an illuminance distribution on the irradiation plane S in the light emission pattern of FIG. 7, that is, in the narrow-angle mode. FIG. 12 is a diagram illustrating a simulation result of an illuminance distribution on the irradiation plane S in the light emission pattern of FIG. 8, that is, in the intermediate mode. FIGS. 10 to 12 illustrate the illuminance distribution on the irradiation plane S when viewed from the +Z side. In FIGS. 10 to 12, a color in the drawings closer to white indicates a higher illuminance of the irradiation light, and a color in the drawings closer to black indicates a lower illuminance of the irradiation light. For example, in the example illustrated in FIG. 10, the illuminance in dark regions B3 is low at the four corner portions of the rectangular region on the irradiation plane S. When the entire circumference of the black region is surrounded by the white region, the illuminance of the black region is higher than that of the white region.

A first irradiation region A1 in FIG. 10 indicates a region where the illuminance was high in the illuminance distribution in the wide-angle mode. In the example illustrated in FIG. 10, the illuminance in a circular black region B1 located in the central portion of the first irradiation region A1 was the highest, and the illuminance decreased gradually in the order of an annular black region B2, an annular white region W1, and an annular white region W2. A second irradiation region A2 in FIG. 11 indicates a region where the illuminance was high in the illuminance distribution in the narrow-angle mode. A third irradiation region A3 in FIG. 12 indicates a region where the illuminance was high in the illuminance distribution in the intermediate mode. The first irradiation region A1 in the wide-angle mode was larger than the second irradiation region A2 in the narrow-angle mode. The third irradiation region A3 in the intermediate mode was intermediate in size between the first irradiation region A1 and the second irradiation region A2.

As illustrated in FIG. 10, the difference in illuminance of the irradiation light on the irradiation plane S was small in the first irradiation region A1. It was understood from this that the illuminance of the irradiation light can be made uniform in the wide-angle mode of the light-emitting module 100. As illustrated in FIG. 11, the difference in illuminance of the irradiation light on the irradiation plane S was small in the second irradiation region A2. It was understood from this that the illuminance of the irradiation light can be made uniform in the narrow-angle mode of the light-emitting module 100. As illustrated in FIG. 12, the difference in illuminance of the irradiation light on the irradiation plane S was small in the third irradiation region A3. It was understood from this that the illuminance of the irradiation light can be made uniform in the intermediate mode of the light-emitting module 100.

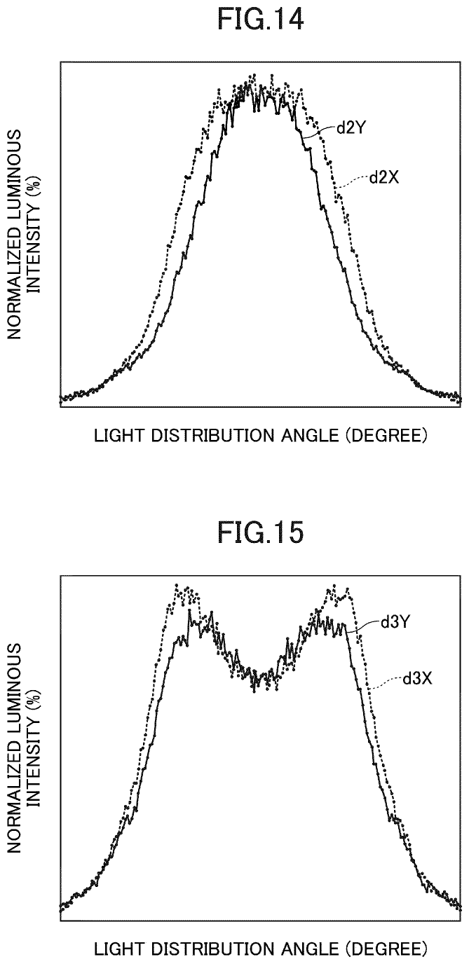

FIG. 13 is a diagram illustrating a simulation result of light distribution in the light emission pattern of FIG. 6. FIG. 14 is a diagram illustrating a simulation result of light distribution in the light emission pattern of FIG. 7. FIG. 15 is a diagram illustrating a simulation result of light distribution in the light emission pattern of FIG. 8. The vertical axis in each of FIGS. 13 to 15 represents the normalized luminous intensity normalized by the maximum luminous intensity. In FIGS. 13 to 15, each of light distributions d1X, d2X, and d3X represents a light distribution in the X direction passing through the light-source center line 2C. Each of light distributions d1Y, d2Y, and d3Y represents a light distribution in the Y direction passing through the light-source center line 2C.

In the wide-angle mode illustrated in FIG. 13, the wide-angle light distribution was obtained as compared with the narrow-angle mode illustrated in FIG. 14. In the intermediate mode illustrated in FIG. 15, the intermediate light distribution between the light distribution in the wide-angle mode and the light distribution in the narrow-angle mode was obtained.

As described above, in the present embodiment, the light-emitting module 100 can emit the light L1 having the first light distribution angle θ1 and the light L2 having the second light distribution angle θ2, and the first light distribution angle θ1 is greater than the second light distribution angle θ2. Thus, the light-emitting module 100 can change the light distribution. In the present embodiment, the central illuminance of the light emitted from the light-emitting module 100 can be increased and the illuminance of the irradiation light can be made uniform in both the wide-angle light distribution and the narrow-angle light distribution, and the lens 1 and the light-emitting module 100 suitable for variable light distribution can be provided.

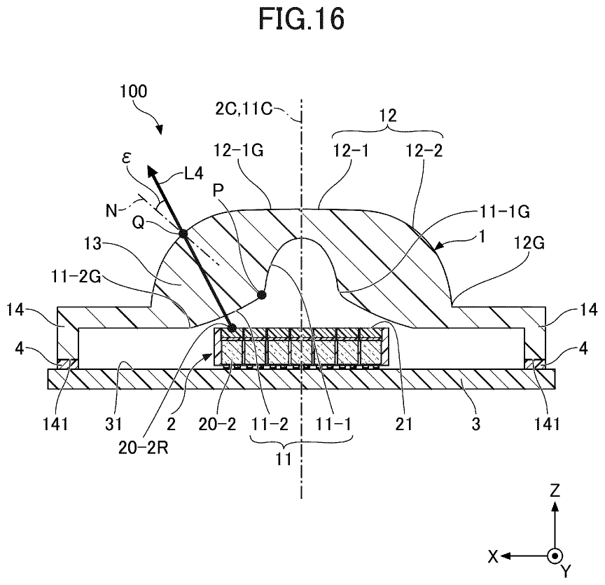

FIG. 16 is a diagram for explaining an angle ε formed by a normal line N to the convex light-exiting surface 12-2 and a light beam L4. The normal line N to the convex light-exiting surface 12-2 passes through an intersection point Q at which the light beam L4 and the convex light-exiting surface 12-2 intersect each other. The light beam L4 is a light beam emitted from one light-emitting point 20-2R in the second light-emitting units 20-2.

As illustrated in FIG. 16, the light-emitting module 100 has the intersection point Q at which the light beam L4 emitted from one light-emitting point 20-2R of the plurality of second light-emitting units 20-2 and the convex light-exiting surface 12-2 intersect each other in a cross section passing through the center line 11C of the light incident surface 11. In the light-emitting module 100, the angle ε formed by the light beam L4 and the normal line N to the convex light-exiting surface 12-2, the normal line N passing through the intersection point Q is in a range of 0 degrees to 90 degrees, and preferably in a range of 0 degrees to 50 degrees.

Because the angle ε is in a range of 0 degrees to 90 degrees, when the light L2 emitted from the plurality of second light-emitting units 20-2 and incident on the light-transmissive portion 13 of the lens 1 passes through the light-transmissive portion 13 of the lens 1 and enters the convex light-exiting surface 12-2, the incident angle of the light L2 becomes small. This can make the light beam L4 that passes through the light-transmissive portion 13 of the lens 1 and is incident on the convex light-exiting surface 12-2 to be less likely to be totally reflected by the convex light-exiting surface 12-2. The light loss due to the total reflection is reduced. As a result, in the narrow-angle mode, the central illuminance of the light emitted from the light-emitting module 100 can be increased, and the illuminance of the irradiation light can be made uniform.

### Dark Portion Reduction Effect

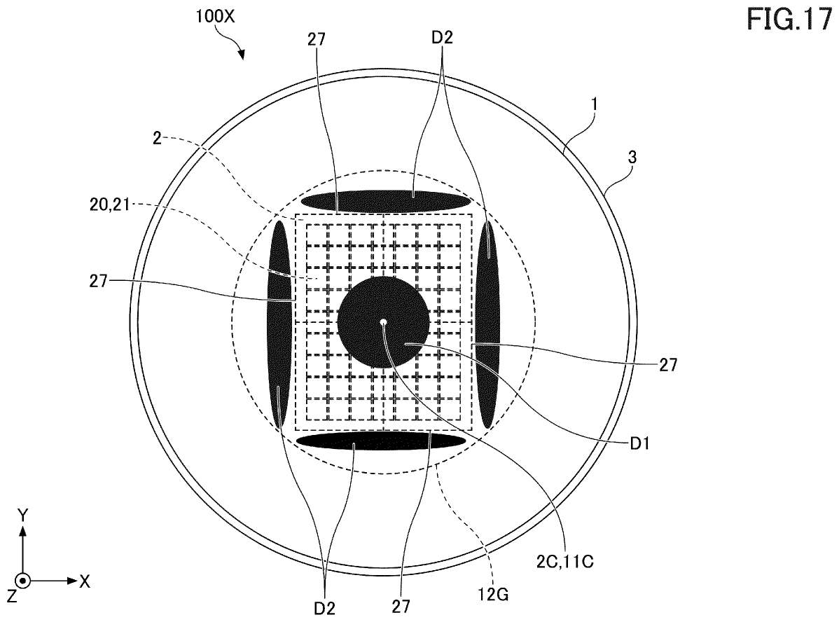

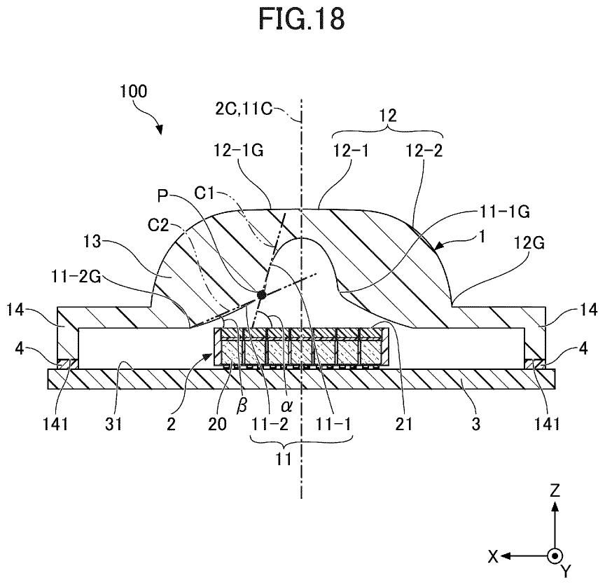

An effect of reducing a dark portion in the light-emitting module 100 will be described with reference to FIGS. 17 and 18. The term “dark portion” refers to a portion that is observed as being dark when the light-emitting module is observed from above and around the center line of the light incident surface of the lens in a state where all the light-emitting units included in the light-emitting module are turned off.

FIG. 17 is a schematic top view of a light-emitting module 100X for explaining a dark portion observed in the light-emitting module 100X in a top view. The light-emitting module 100X is different from the light-emitting module 100 according to the first embodiment in that a measure against the dark portion is not taken. In FIG. 17, a first dark portion D1 is a dark portion generated at the center of the light-emitting module 100X in a top view. A second dark portion D2 is a dark portion generated near the outside of the lateral surface of the light source 2 of the light-emitting module 100X. The first dark portion D1 and the second dark portion D2 are generated, which may deteriorate the appearance of the light-emitting module 100X.

In the light-emitting module 100, the flat surface 12-1 illustrated in FIG. 2 may include a rough surface. The rough surface of the flat surface 12-1 is, for example, a surface having a surface roughness that is twice or less the average wavelength of the light emitted from the light source 2. The surface roughness of the flat surface 12-1 is represented as, for example, an arithmetic average roughness Ra. Ra is, for example, in a range of 0.2 μm to 18 μm. The rough surface of the flat surface 12-1 is obtained by molding the lens 1 using a mold in which a portion corresponding to the flat surface 12-1 has undergone surface roughening by sandblasting, electric discharge surface texturing, or the like. The flat surface 12-1 including the rough surface can reduce the first dark portion D1 generated in the central portion of the light source 2 in FIG. 17 when the light-emitting module 100 is viewed from above. This can improve the appearance of the light-emitting module 100 compared with the case in which the first dark portion D1 is generated.

FIG. 18 is a diagram for explaining an angle α formed by a tangent line C1 (i.e., first tangent line) to the first light incident surface 11-1 and a plane parallel to the flat surface 12-1, and an angle β formed by a tangent line C2 (i.e., second tangent line) to the second light incident surface 11-2 and a plane parallel to the flat surface 12-1 in the light-emitting module 100. Both the tangent line C1 and the tangent line C2 pass through the inflection point P.

In FIG. 18, the angle α is formed by the tangent line C1 to the first light incident surface 11-1, the tangent line C1 passing through the inflection point P, and a surface parallel to the flat surface 12-1 in a cross section passing through the center line 11C. The angle β is formed by the tangent line C2 to the second light incident surface 11-2, the tangent line C2 passing through the inflection point P, and a surface parallel to the flat surface 12-1 in a cross section passing through the center line 11C. In the light-emitting module 100, the difference between the angle α and the angle β is preferably greater than 0 degrees and less than 30 degrees. When the difference between the angle α and the angle β is greater than 0 degrees and less than 30 degrees, the second dark portion D2 generated near the outside of the lateral surface of the light source 2 is reduced when the light-emitting module 100 is viewed from above. This can improve the appearance of the light-emitting module 100 compared with the case in which the second dark portion D2 is generated.

### MODIFIED EXAMPLE

### First Modified Example

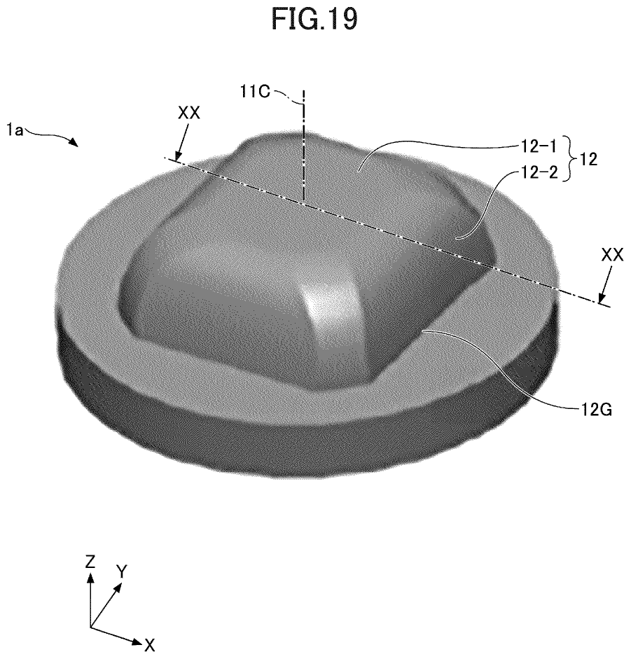

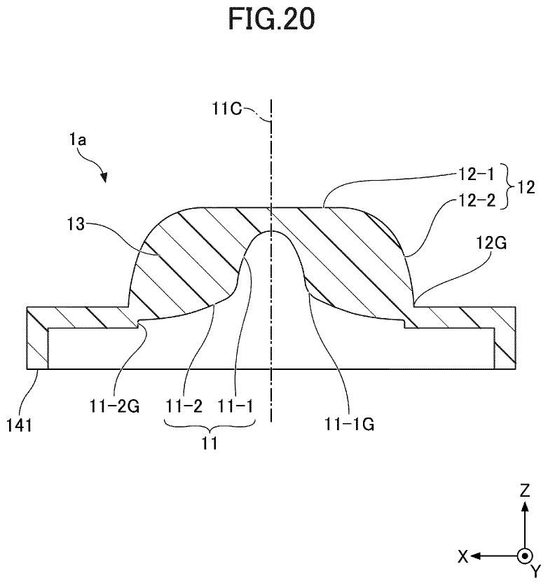

A lens according to a first modified example will be described with reference to FIGS. 19 and 20. FIG. 19 is a schematic perspective view of a lens 1a according to the first modified example. FIG. 20 is a schematic cross-sectional view taken along the line XX-XX of FIG. 19.

The lens 1a according to the present modified example is different from the light-emitting module 100 according to the first embodiment in that the outer shape of the light-exiting surface 12 is substantially quadrangular in a top view. The light-exiting surface 12 of the lens 1a has such an outer shape that four corner portions of the substantially quadrangle are rounded. This can facilitate light emission from the light-exiting surface 12 having the four rounded corner portions. The outer shape may be a quadrangular shape with four right-angled corner portions. Effects similar to those produced by the lens 1 included in the light-emitting module 100 according to the first embodiment can also be obtained in the present modified example. The outer shape of the light incident surface 11 may be circular in a top view.

### Second Modified Example

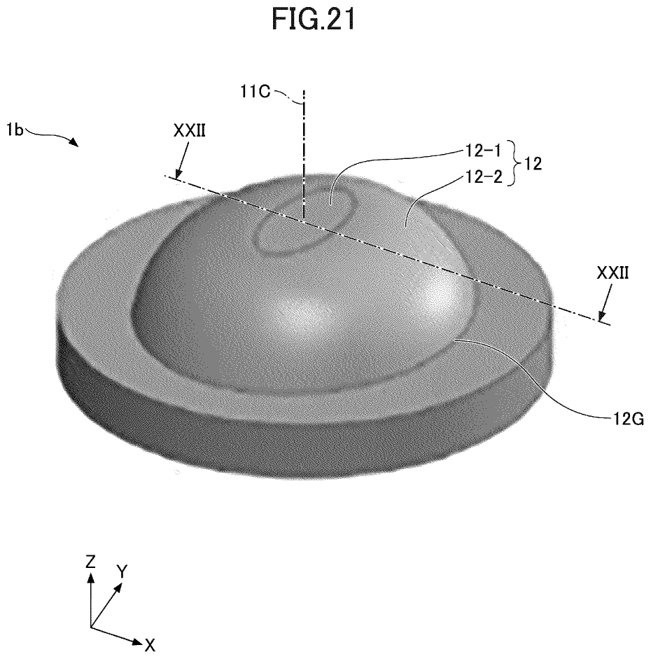

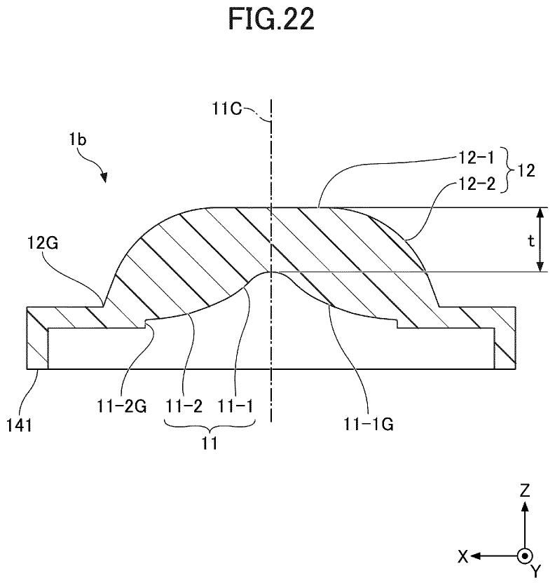

A lens according to a second modified example will be described with reference to FIGS. 21 and 22. FIG. 21 is a schematic perspective view of a lens 1b according to the second modified example. FIG. 22 is a schematic cross-sectional view taken along the line XXII-XXII in FIG. 21.

In the lens 1b according to the present modified example, the outer shape and the outer edge 12G of the flat surface 12-1 are elliptical in a top view. In the lens 1b, a thickness t of a portion of the light incident surface 11 intersecting the center line 11C is greater than that of the light-emitting module 100 according to the first embodiment, and the first light incident surface 11-1 and the second light incident surface 11-2 are smoothly continuous. In these respects, the present modified example is different from the light-emitting module 100 according to the first embodiment. Because the imaging range of a general imaging device is rectangular, the outer shape and the outer edge 12G of the flat surface 12-1 are elliptical in a top view, so that the illuminance of the irradiation light can be made uniform. In the lens 1b according to the present modified example, the first light incident surface 11-1 and the second light incident surface 11-2 are smoothly continuous (that is, both the angle α and the angle β illustrated in FIG. 18 are small, and the difference between the angle α and the angle β is greater than 0 degrees and less than 30 degrees), so that the appearance of the light-emitting module is further improved when the light-emitting module including the lens 1b is viewed from above. Effects similar to those produced by the lens 1 included in the light-emitting module 100 according to the first embodiment can also be obtained in the present modified example. The outer shape of the light incident surface 11 may be circular in a top view.

### Second Embodiment

Next, a light-emitting module according to a second embodiment will be described. The same names and reference characters as those in the previously described embodiment indicate the same or similar members or configurations, and detailed descriptions thereof are omitted as appropriate. This applies to the modified example and the embodiments which will be described hereinafter.

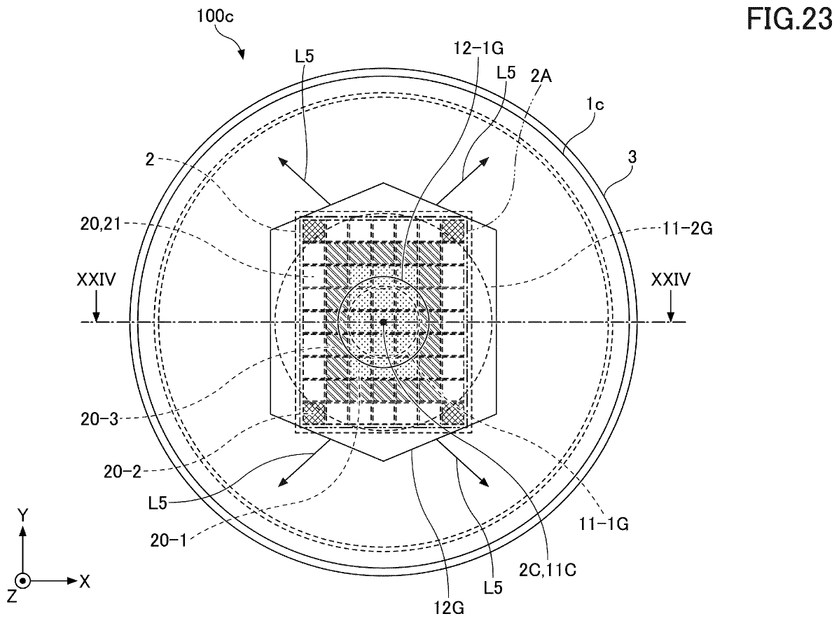

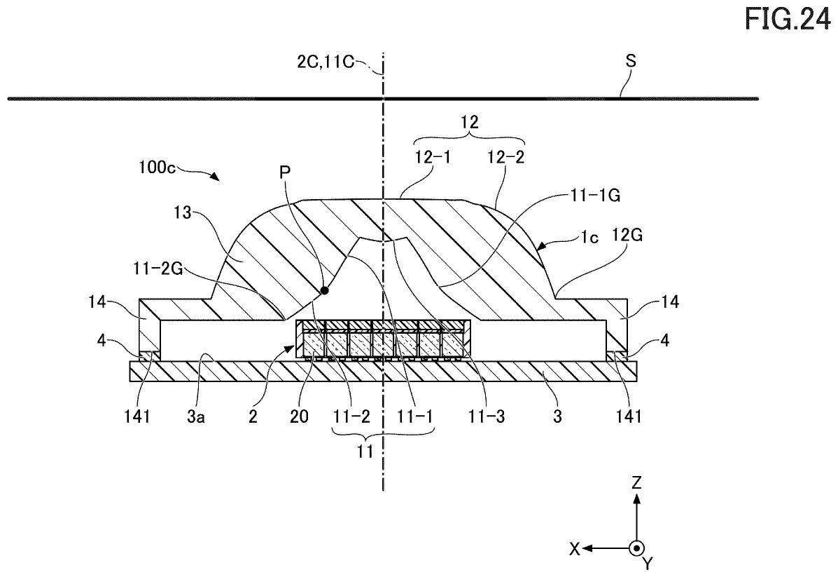

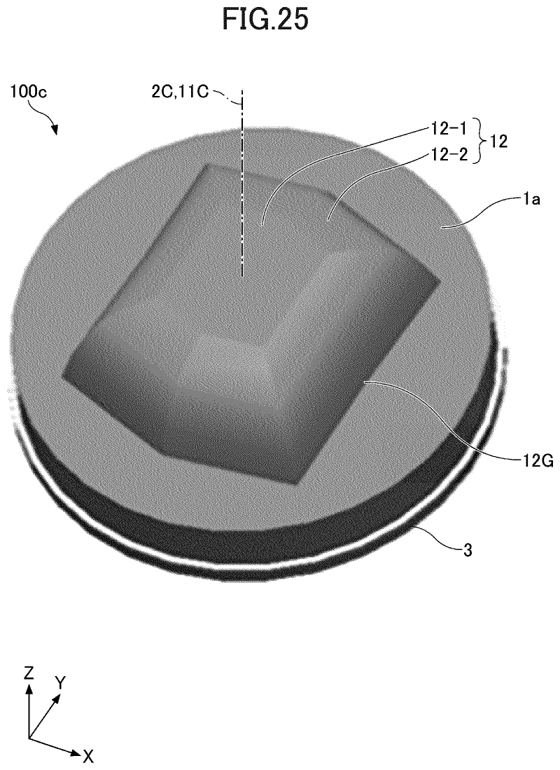

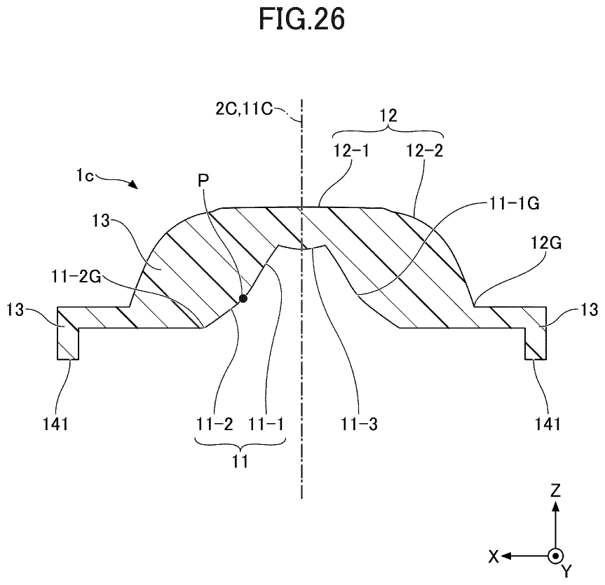

A configuration of the light-emitting module according to the second embodiment is described with reference to FIGS. 23 to 26. FIG. 23 is a schematic top view illustrating the overall configuration of a light-emitting module 100c according to the second embodiment. FIG. 24 is a schematic cross-sectional view taken along the line XXIV-XXIV in FIG. 23. FIG. 25 is a schematic perspective view illustrating the overall configuration of the light-emitting module 100c. FIG. 26 is a schematic cross-sectional view of a lens 1c in the light-emitting module 100c. FIG. 26 illustrates a cross section of the lens 1c corresponding to the line XXIV-XXIV in FIG. 23.

In the light-emitting module 100c according to the present embodiment, as illustrated in FIG. 24, the first light incident surface 11-1 of the lens 1c includes a convex light-incident portion 11-3 that intersects the center line 11C and is convex downward. As illustrated in FIG. 23, the outer shape of the light-exiting surface 12 of the lens 1c is a polygonal shape having an even number of vertices equal to or greater than six in a top view. In these respects, the light-emitting module 100c is different from the light-emitting module 100 according to the first embodiment.

In the example illustrated in FIG. 24, the convex light-incident portion 11-3 is disposed to face the light source 2. Because the first light incident surface 11-1 includes the convex light-incident portion 11-3 in the vicinity of the center line 11C of the light incident surface 11, a positive refractive power is obtained by the convex light-incident portion 11-3 and the flat surface 12-1. The positive refractive power causes the light passing through the convex light-incident portion 11-3 among the light passing through the first light incident surface 11-1 to converge, so that the central illuminance of the irradiation light from the lens 1a is increased.

The outer shape of the light-exiting surface 12 corresponds to the shape of the outer edge 12G of the light-exiting surface 12. In the example illustrated in FIGS. 23 and 25, the outer shape of the light-exiting surface 12 is hexagonal in a top view. The hexagonal shape is longer in the Y direction than in the X direction.

The imaging range of a general imaging device is rectangular. Assuming that the shape of the outer edge of the light-exiting surface of the lens is rectangular, most of the light emitted from the rectangular light source is directed perpendicularly to each of the four sides of the rectangular light-exiting surface of the lens. Thus, it is difficult to obtain irradiation light having a quadrangular outer shape, and in particular, the vicinity of the four corner portions of the imaging range may be irradiated with a reduced amount of light. On the other hand, because the outer shape of the light-exiting surface 12 is a polygon having an even number of vertices and six or more sides in a top view, most of the light emitted from the light source 2 is refracted by the plurality of sides of the light-exiting surface 12 that are inclined to the four sides of the rectangular light source 2. For example, as illustrated in FIG. 23, the vicinity of four corner portions of the rectangular irradiation range on the irradiation plane S can be irradiated with light L5 emitted from the light source 2 and refracted by a plurality of sides of the light-exiting surface 12. Therefore, on the irradiation plane S irradiated with the light from the lens 1, irradiation light having a quadrangular outer shape when viewed from a direction orthogonal to the irradiation plane is easily obtained. Because the imaging range of a general imaging device is rectangular, the use efficiency of the irradiation light in imaging is increased by irradiation with the light having a quadrangular outer shape when viewed from the direction orthogonal to the irradiation plane, compared with a case in which the outer shape of the irradiation light is circular. In particular, the outer shape of the light-exiting surface 12 is hexagonal or octagonal in a top view, and thus the outer shape of the irradiation light becomes loser to a quadrangle when viewed from a direction orthogonal to the irradiation plane. This can make it possible to further increase the use efficiency of the irradiation light in imaging.

As described above, in the light-emitting module 100c, the light source 2 has the rectangular light-emitting region 2A, the outer shape of the light-exiting surface 12 is a polygonal shape having an even number of vertices equal to or greater than six, and one side of the outer shape of the light-emitting region 2A and one side of the outer shape of the light-exiting surface 12 intersect each other. In the example illustrated in FIG. 23, in a top view, each of the four sides of the outer shape of the light-emitting region 2A intersects the outer edge 12G of the light-exiting surface 12. Because one side of the outer shape of the light-emitting region 2A and one side of the outer shape of the light-exiting surface 12 intersect each other, it is easy to obtain irradiation light having a quadrangular outer shape on the irradiation plane S irradiated with light from the light-emitting module 100c, when viewed from a direction orthogonal to the irradiation plane S. This can increase the use efficiency of the irradiation light in imaging.

The operational effects other than those described above are substantially the same as those of the light-emitting module 100 according to the first embodiment. In the outer shape of the light-exiting surface 12, the polygon having an even number of vertices and six or more sides may be a regular polygon or a polygon other than a regular polygon.

### Third Embodiment

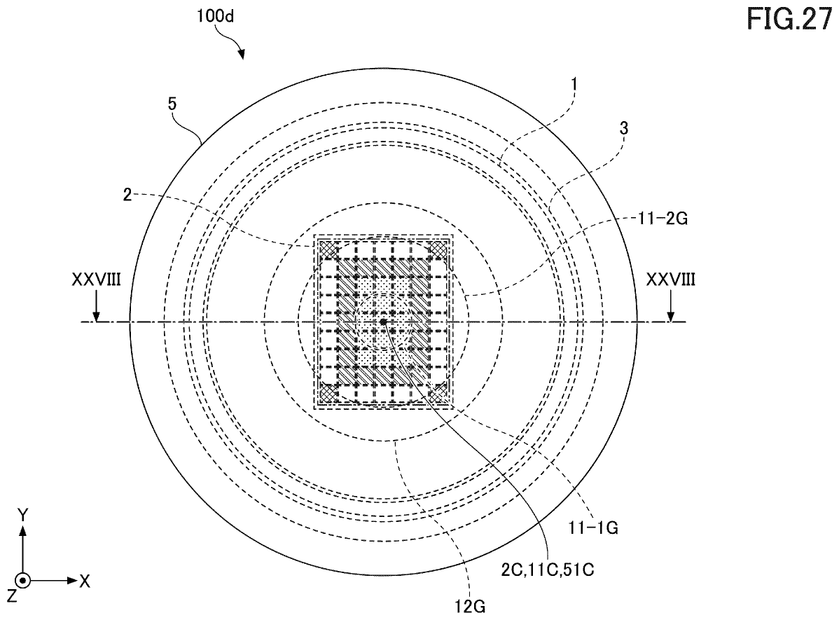

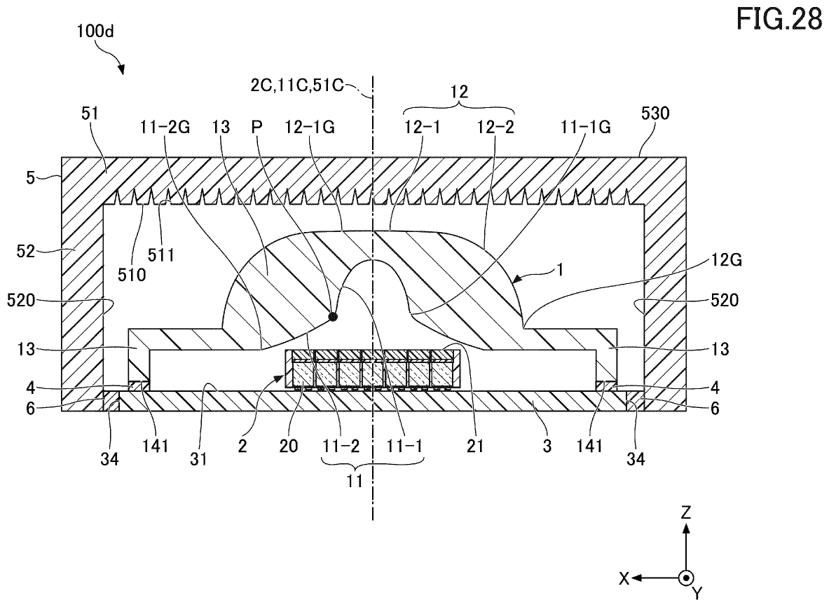

Next, a light-emitting module according to a third embodiment will be described with reference to FIGS. 27 to 28. FIG. 27 is a schematic top view of a light-emitting module 100d according to the third embodiment. FIG. 28 is a schematic cross-sectional view taken along the line XXVIII-XXVIII in FIG. 27.

As illustrated in FIGS. 27 and 28, the light-emitting module 100d according to the present embodiment is different from the light-emitting module 100 according to the first embodiment in that the light-emitting module 100d further includes a light-transmissive member 5 having a cover portion 51 including a light diffusion portion 511. The cover portion 51 is located above the light-exiting surface 12 of the lens 1. The light diffusion portion 511 is disposed so as to cover the light-exiting surface 12 of the lens 1.

In the example illustrated in FIG. 27, an outer shape of the light-emitting module 100d is circular in a top view. In a top view, the outer shape of the light-transmissive member 5 is the outer shape of the light-emitting module 100d. However, the outer shapes of the light-emitting module 100d and the light-transmissive member 5 are not limited to a circular shape in a top view, and may have another shape such as an elliptical shape, a rectangular shape, or a polygonal shape.

In the example illustrated in FIG. 28, the light-transmissive member 5 further includes a second support portion 52 supporting the cover portion 51. The light-emitting module 100d further includes a second adhesive member 6 disposed between an outer lateral surface 34 of the substrate 3 and an inner lateral surface 520 of the second support portion 52 of the light-transmissive member 5. The cover portion 51 faces the light-exiting surface 12 of the lens 1.

### Light-Transmissive Member 5

The light-transmissive member 5 is disposed so as to cover the lens 1. The cover portion 51 transmits the light that has been emitted from the light source 2 and has passed through the lens 1. The light-transmissive member 5 contains at least one of a resin material, such as a polycarbonate resin, an acrylic resin, a silicone resin, or an epoxy resin, or a glass material, these materials having transmissivity to the light emitted from the light source 2. The transmissivity of the cover portion 51 is preferably a property that allows 60% or more of the light emitted from the light source 2 to be transmitted.

In the example illustrated in FIG. 28, the cover portion 51 and the second support portion 52 are a monolithic member without using an adhesive member. From another viewpoint, the cover portion 51 is continuous to the second support portion 52. However, the cover portion 51 and the second support portion 52 may be individual members bonded with an adhesive member.

In the example illustrated in FIGS. 27 and 28, the cover portion 51 of the light-transmissive member 5 has a light-transmissive member incident surface 510 facing the light-exiting surface 12 of the lens 1, and a light-transmissive member emission surface 530 located on the opposite side to the light-transmissive member incident surface 510. The light diffusion portion 511 is provided on the light-transmissive member incident surface 510. The light diffusion portion 511 includes a plurality of concentric protruding portions centered on the center line 51C of the cover portion 51. The center line 51C of the cover portion 51 overlaps the center line 11C of the light incident surface 11 of the lens 1 and the light-source center line 2C of the light source 2 in a top view. The light diffusion portion 511 may be a Fresnel lens having a Fresnel shape. The light diffusion portion 511 may be formed by applying the above-described light diffusion substance to the light-transmissive member incident surface 510, or the above-described light diffusion substance may be contained inside the cover portion 51.

The second support portion 52 supports the cover portion 51 such that the cover portion 51 is disposed above the light-transmissive portion 13. The second support portion 52 is a circular annular portion of the light-transmissive member 5 in a top view. The second support portion 52 is a cylindrical portion provided so as to extend downward while being outward of the substrate 3 and the lens 1. The second support portion 52 is disposed with a part of the inner lateral surface 520 facing the outer lateral surface 34 of the substrate 3. The second adhesive member 6 is disposed between the outer lateral surface 34 of the substrate 3 and the inner lateral surface 520 of the second support portion 52 of the light-transmissive member 5, whereby the light-transmissive member 5 is fixed to the substrate 3.

In the present embodiment, the light-emitting module 100d including the light-transmissive member 5 can control light distribution using the light-transmissive portion 13 of the lens 1 and the cover portion 51 of the light-transmissive member 5, so that a degree of freedom in controlling the light distribution increases. The effects other than those described above in the light-emitting module 100d are substantially the same as those in the light-emitting module 100 according to the first embodiment.

While preferred embodiments have been described in detail above, the present disclosure is not limited to the above-described embodiments. Various modifications and substitutions can be made to the above-described embodiments without departing from the scope described in the claims.

The ordinal numbers, quantity, and other numbers used in the description of the embodiments are all exemplified to specifically describe the technique of the present disclosure, and the present disclosure is not limited to the numbers exemplified. In addition, the connection relationship between the components is exemplified to specifically describe the technique of the present disclosure, and the connection relationship for implementing the function of the present disclosure is not limited thereto.

Because the light-emitting module and the lens of the present disclosure can control light distribution, and thus are suitable for use in applications such as lighting, camera flashes, and in-vehicle headlights. However, the light-emitting module and the lens of the present disclosure are not limited to these applications.

### REFERENCE CHARACTER LIST

1. 1a, 1b, 1c Lens
11 Light incident surface
11C Center line
11-1 First light incident surface
11-1G Outer edge of first light incident surface
11-2 Second light incident surface
11-2G Outer edge of second light incident surface
11-3 Convex light-incident portion
12-1 Flat surface
12-2 Convex light-exiting surface
12G Outer edge of light-exiting surface
12-1G Outer edge of flat surface
13 Light-transmissive portion
14 First support portion
2 Light source
2C Light-source center line
2A Light-emitting region
2K Corner portion
3 Substrate
4 First adhesive member
5 Light-transmissive member
6 Second adhesive member
20 Light-emitting unit
20-1 First light-emitting unit
20-2 Second light-emitting unit
20-2R Light-emitting point
20-3 Third light-emitting unit
21 Light-emitting surface
22 Light diffusion member
23 Wavelength conversion member
24 Light-emitting element
25 Covering member
26 Electrode
27 Outer lateral surface
31 Upper surface
32 Wiring
33 Electrically conductive member
34 Outer lateral surface
51 Cover portion
51C Center line
52 Second support portion
100, 100c, 100d Light-emitting module
141 Lower surface
250 Resin member
510 Light-transmissive member incident surface
511 Light diffusion portion
520 Inner lateral surface
530 Light-transmissive member emission surface
A1 First irradiation region
A2 Second irradiation region
A3 Third irradiation region
C1, C2 Tangent line
D1 First dark portion
D2 Second dark portion
Gp Gap
L1, L2, L3 Light
L4 Light beam
N Normal line
P Inflection point
Q Intersection point
S Irradiation plane
t Thickness
α, β Angle
θ1 First light distribution angle
θ2 Second light distribution angle

What is claimed is:

1. A light-emitting module comprising:
a lens having:
a light incident surface that is concave upward, and
a light-exiting surface located on a side opposite the light incident surface; and
a light source comprising a plurality of light-emitting units disposed below the lens; wherein:
in a cross section passing through a center line of the light incident surface, the light incident surface comprises:
an inflection point at which the light incident surface changes from a concave surface to a convex surface,
a first light incident surface located above the inflection point and comprising a concave surface that is continuous with the inflection point and is concave upward, the first light incident surface being located in a central portion of the light incident surface in a top view, and
a second light incident surface located below the inflection point and comprising a convex surface that is continuous with the inflection point and is convex downward, the second light incident surface being located outward of the first light incident surface in the top view;
the light-exiting surface comprises:
a flat surface located on a side opposite the first light incident surface, and
a convex light-exiting surface that is located outward of the flat surface in the top view and is convex upward; and
the plurality of light-emitting units include:
one or more first light-emitting units disposed in a central portion in the top view, and
a plurality of second light-emitting units located outward of the one or more first light-emitting units in the top view;
the light-emitting module is configured to emit light that has passed through the lens and that has a first light distribution angle when only the one or more first light-emitting units are caused to emit light; and
the light-emitting module is configured to emit light that has passed through the lens and that has a second light distribution angle less than the first light distribution angle when only the plurality of second light-emitting units are caused to emit light.

2. The light-emitting module according to claim 1, wherein the first light incident surface of the lens comprises a convex light-incident portion intersecting the center line, the convex light-incident portion being convex downward.

3. The light-emitting module according to claim 1, wherein an outer shape of the light-exiting surface of the lens is a polygonal shape having an even number of vertices equal to or greater than six in the top view.

4. The light-emitting module according to claim 3, wherein the outer shape of the light-exiting surface of the lens is hexagonal or octagonal in the top view.

5. The light-emitting module according to claim 1, wherein the flat surface comprises a rough surface.

6. The light-emitting module according to claim 1, wherein, in the cross section passing through the center line, a difference between an angle α and an angle β is greater than 0 degrees and less than 30 degrees, the angle α being formed by a first tangent line to the first light incident surface and a plane parallel to the flat surface, the first tangent line passing through the inflection point, the angle β being formed by a second tangent line to the second light incident surface and the plane parallel to the flat surface, the second tangent line passing through the inflection point.

7. The light-emitting module according to claim 1, wherein:
the plurality of light-emitting units are arranged in a matrix; and
in the top view, the plurality of second light-emitting units are located at an outermost periphery of the plurality of light-emitting units.

8. The light-emitting module according to claim 1, wherein, in the top view, one or more of the plurality of second light-emitting units overlap the second light incident surface.

9. The light-emitting module according to claim 1, wherein in the top view, the flat surface and the one or more first light-emitting units overlap each other, and the convex light-exiting surface and one or more of the plurality of second light-emitting units overlap each other.

10. The light-emitting module according to claim 1, wherein:
the light source further comprises a covering member; and
the plurality of light-emitting units are integrally held by the covering member.

11. The light-emitting module according to claim 1, further comprising a light-transmissive member comprising a cover portion comprising a light diffusion portion, the cover portion being located above the light-exiting surface of the lens.

12. The light-emitting module according to claim 1, wherein, in the cross section passing through the center line, the light-emitting module has an intersection point at which the convex light-exiting surface intersects a light beam emitted from one light-emitting point of the plurality of second light-emitting units, and an angle formed by a normal line to the convex light-exiting surface and the light beam is in a range of 0 degrees to 90 degrees, the normal line passing through the intersection point.

13. The light-emitting module according to claim 1, wherein, in the top view, the light source comprises a light-emitting region having a rectangular shape, an outer shape of the light-exiting surface is a polygonal shape having an even number of vertices equal to or greater than six, and one side of an outer shape of the light-emitting region and one side of the outer shape of the light-exiting surface intersect each other.

14. A lens comprising:
a light incident surface that is concave upward; and
a light-exiting surface located on a side opposite the light incident surface;
wherein:
in a cross section passing through a center line of the light incident surface, the light incident surface comprises:
an inflection point at which the light incident surface changes from a concave surface to a convex surface,
a first light incident surface located above the inflection point and comprising a concave surface that is continuous with the inflection point and is concave upward, the first light incident surface being located in a central portion of the light incident surface in a top view, and
a second light incident surface located below the inflection point and comprising a convex surface that is continuous with the inflection point and is convex downward, the second light incident surface being located outward of the first light incident surface in the top view;
the light-exiting surface comprises:
a flat surface located on a side opposite the first light incident surface, and
a convex light-exiting surface that is located outward of the flat surface in the top view and is convex upward; and
an outer shape of the light-exiting surface is a polygonal shape having an even number of vertices equal to or greater than six in the top view.

15. The lens according to claim 14, wherein the outer shape of the light-exiting surface is hexagonal or octagonal in the top view.
